(19) United States
(12) Patent Application Publication
(10) Pub. No.: US 2025/0072558 A1
(43) Pub. Date: Mar. 6, 2025

(54) FOOTWEAR

(71) Applicant: ASICS CORPORATION, Kobe-shi (JP)

(72) Inventors: Genki HATANO, Kobe-shi (JP); Shingo TAKASHIMA, Kobe-shi (JP); Yuta KAWAI, Kobe-shi (JP)

(73) Assignee: ASICS CORPORATION, Kobe-shi (JP)

(21) Appl. No.: 18/820,711

(22) Filed: Aug. 30, 2024

(30) Foreign Application Priority Data
Sep. 4, 2023 (JP) 2023-142978

(51) Int. Cl. A43B 13/18; A43B 17/00; B29C 64/124; B29L 31/50; B33Y 10/00; B33Y 80/00

(52) U.S. Cl. CPC A43B 13/186; A43B 17/003; B33Y 80/00; B29C 64/124; B29L 2031/504; B29L 2031/507; B33Y 10/00

(57) ABSTRACT

Footwear includes a footbed including a cushioning portion configured of a three-dimensional mesh structure body with multiple unit structures repeatedly arranged to be adjacent to one another. In one aspect, the occupied volume ratio of the cushioning portion is larger in a medial forefoot area than a lateral forefoot area, is larger in a medial midfoot area than a lateral midfoot area, is larger in a medial rearfoot area than a lateral rearfoot area, is smaller in the medial forefoot area than the medial midfoot area, is smaller in the lateral forefoot area than the lateral midfoot area, is equal in the medial midfoot area and the medial rearfoot area or is smaller in the medial midfoot area than the medial rearfoot area.

### CROSS-REFERENCE TO RELATED APPLICATION

This application claims priority to Japanese Patent Application No. 2023-142978, the disclosures of which are incorporated herein by reference in their entirety.

### BACKGROUND

### Technical Field

The present disclosure relates to footwear.

### Background Information

In recent years, the whole or part of a sole or a sockliner of footwear has been constructed from a shaped object shaped by three-dimensional additive manufacturing. For example, JP2018-187363 and US2018/0049514 disclose a shoe comprising a sole produced by three-dimensional additive manufacturing, and US2018/0228401 discloses a sockliner produced by three-dimensional additive manufacturing.

### SUMMARY

In general, footwear is required to have various functions depending on the use or the like thereof. For example, required properties greatly differ between footwear used for running, which involves many kicking and landing motions, and footwear used for specific ball sports typified by tennis and basketball, which involve many cutting movements. In addition, even in the case of footwear used for running, required properties greatly differ between the case of considering heel strike running or midfoot strike running and the case of considering forefoot strike running.

In this regard, when a sole and a sockliner are produced by three-dimensional additive manufacturing, various structural improvements can be made to the sole and the sockliner because of the high degree of freedom of design; thus, it is possible to provide high-performance footwear having a function adapted to various uses. However, footwear provided with a sole or sockliner that has been improved based on such a viewpoint is still not sufficient in a practical sense, as far as the present inventors are aware.

Accordingly, the present disclosure has been made in view of the above-described circumstances, allowing provision of footwear having a function more suitable for intended use.

Footwear according to the present disclosure includes a footbed that supports the sole of a foot of a wearer and includes a ground-contacting surface. The footbed includes a forefoot area that supports a toe portion and a ball portion of the foot of the wearer, a midfoot area that supports an arch portion of the foot of the wearer, and a rearfoot area that supports a heel portion of the foot of the wearer. The forefoot area, the midfoot area, and the rearfoot area are located to be continuous along a front-rear direction of the footwear. The forefoot area includes a medial forefoot area and a lateral forefoot area which are defined by a shoe center of the footwear when viewed along a direction perpendicular to the ground-contacting surface. The midfoot area includes a medial midfoot area and a lateral midfoot area which are defined by the shoe center of the footwear when viewed along the direction perpendicular to the ground-contacting surface. The rearfoot area includes a medial rearfoot area and a lateral rearfoot area which are defined by the shoe center of the footwear when viewed along the direction perpendicular to the ground-contacting surface. The footbed includes a cushioning portion formed from a three-dimensional mesh structure in which multiple unit structures are repeatedly arranged to be adjacent to one another, the cushioning portion being located across the medial forefoot area, the lateral forefoot area, the medial midfoot area, the lateral midfoot area, the medial rearfoot area, and the lateral rearfoot area.

In footwear according to a first aspect of the present disclosure, an occupied volume ratio of the cushioning portion in a portion located in the medial forefoot area is larger than an occupied volume ratio of the cushioning portion in a portion located in the lateral forefoot area, an occupied volume ratio of the cushioning portion in a portion located in the medial midfoot area is larger than an occupied volume ratio of the cushioning portion in a portion located in the lateral midfoot area, an occupied volume ratio of the cushioning portion in a portion located in the medial rearfoot area is larger than an occupied volume ratio of the cushioning portion in a portion located in the lateral rearfoot area, the occupied volume ratio of the cushioning portion in the portion located in the medial forefoot area is smaller than the occupied volume ratio of the cushioning portion in the portion located in the medial midfoot area, the occupied volume ratio of the cushioning portion in the portion located in the lateral forefoot area is smaller than the occupied volume ratio of the cushioning portion in the portion located in the lateral midfoot area, the occupied volume ratio of the cushioning portion in the portion located in the medial midfoot area is equal to or smaller than the occupied volume ratio of the cushioning portion in the portion located in the medial rearfoot area, and the occupied volume ratio of the cushioning portion in the portion located in the lateral midfoot area is equal to or smaller than the occupied volume ratio of the cushioning portion in the portion located in the lateral rearfoot area.

In footwear according to a second aspect of the present disclosure, an occupied volume ratio of the cushioning portion in a portion located in the medial forefoot area is larger than an occupied volume ratio of the cushioning portion in a portion located in the lateral forefoot area, an occupied volume ratio of the cushioning portion in a portion located in the medial midfoot area is larger than an occupied volume ratio of the cushioning portion in a portion located in the lateral midfoot area, an occupied volume ratio of the cushioning portion in a portion located in the medial rearfoot area is larger than an occupied volume ratio of the cushioning portion in a portion located in the lateral rearfoot area, the occupied volume ratio of the cushioning portion in the portion located in the medial forefoot area is equal to or larger than the occupied volume ratio of the cushioning portion in the portion located in the medial midfoot area, the occupied volume ratio of the cushioning portion in the portion located in the lateral forefoot area is equal to or larger than the occupied volume ratio of the cushioning portion in the portion located in the lateral midfoot area, the occupied volume ratio of the cushioning portion in the portion located in the medial midfoot area is larger than the occupied volume ratio of the cushioning portion in the portion located in the medial rearfoot area, and the occupied volume ratio of the cushioning portion in the portion located in the lateral midfoot area is larger than the occupied volume ratio of the cushioning portion in the portion located in the lateral rearfoot area.

In footwear according to a third aspect of the present disclosure, an occupied volume ratio of the cushioning portion in a portion located in the medial forefoot area is smaller than an occupied volume ratio of the cushioning portion in a portion located in the lateral forefoot area, an occupied volume ratio of the cushioning portion in a portion located in the medial midfoot area is smaller than an occupied volume ratio of the cushioning portion in a portion located in the lateral midfoot area, an occupied volume ratio of the cushioning portion in a portion located in the medial rearfoot area is smaller than an occupied volume ratio of the cushioning portion in a portion located in the lateral rearfoot area, the occupied volume ratio of the cushioning portion in the portion located in the medial forefoot area is smaller than the occupied volume ratio of the cushioning portion in the portion located in the medial midfoot area, the occupied volume ratio of the cushioning portion in the portion located in the lateral forefoot area is smaller than the occupied volume ratio of the cushioning portion in the portion located in the lateral midfoot area, the occupied volume ratio of the cushioning portion in the portion located in the medial midfoot area is equal to or smaller than the occupied volume ratio of the cushioning portion in the portion located in the medial rearfoot area, and the occupied volume ratio of the cushioning portion in the portion located in the lateral midfoot area is equal to or smaller than the occupied volume ratio of the cushioning portion in the portion located in the lateral rearfoot area.

In footwear according to a fourth aspect of the present disclosure, an occupied volume ratio of the cushioning portion in a portion located in the medial forefoot area is smaller than an occupied volume ratio of the cushioning portion in a portion located in the lateral forefoot area, an occupied volume ratio of the cushioning portion in a portion located in the medial midfoot area is smaller than an occupied volume ratio of the cushioning portion in a portion located in the lateral midfoot area, an occupied volume ratio of the cushioning portion in a portion located in the medial rearfoot area is smaller than an occupied volume ratio of the cushioning portion in a portion located in the lateral rearfoot area, the occupied volume ratio of the cushioning portion in the portion located in the medial forefoot area is equal to or larger than the occupied volume ratio of the cushioning portion in the portion located in the medial midfoot area, the occupied volume ratio of the cushioning portion in the portion located in the lateral forefoot area is equal to or larger than the occupied volume ratio of the cushioning portion in the portion located in the lateral midfoot area, the occupied volume ratio of the cushioning portion in the portion located in the medial midfoot area is larger than the occupied volume ratio of the cushioning portion in the portion located in the medial rearfoot area, and the occupied volume ratio of the cushioning portion in the portion located in the lateral midfoot area is larger than the occupied volume ratio of the cushioning portion in the portion located in the lateral rearfoot area.

According to the present disclosure, it is possible to provide footwear having a function more suitable for intended use.

### BRIEF DESCRIPTION OF THE DRAWINGS

FIG. 1 is an exploded view of footwear according to a first embodiment;

FIG. 2 is a perspective view of the sockliner shown in FIG. 1 viewed obliquely from the upper right front side;

FIG. 3 is a perspective view of the sockliner shown in FIG. 1 viewed obliquely from the lower left rear side;

FIG. 4 is a plan view of the sockliner shown in FIG. 1;

FIG. 5 is a side view of the sockliner shown in FIG. 1 viewed from the foot lateral side;

FIG. 6 is a partially cut-away perspective view of the sockliner shown in FIG. 1 along the line VI-VI shown in FIGS. 2, 4, and 5;

FIG. 7 is a schematic view for explaining a three-dimensional structure of a base layer portion of the sockliner shown in FIG. 1;

FIG. 8 is a schematic bottom view for explaining occupied volume ratio distribution of a sockliner according to a first configuration example;

FIG. 9 is a schematic bottom view for explaining occupied volume ratio distribution of a sockliner according to a second configuration example;

FIG. 10 is a schematic bottom view for explaining occupied volume ratio distribution of a sockliner according to a third configuration example;

FIG. 11 is a schematic bottom view for explaining occupied volume ratio distribution of a sockliner according to a fourth configuration example;

FIG. 12 is a schematic view for explaining a three-dimensional structure of a base layer portion of a sockliner included in footwear according to a first modification;

FIG. 13 is a schematic view for explaining a three-dimensional structure of a base layer portion of a sockliner included in footwear according to a second modification;

FIG. 14 is a perspective view of footwear according to a second embodiment;

FIG. 15 is a perspective view of footwear according to a third embodiment;

FIG. 16 is a schematic cross-sectional view along the line XVI-XVI shown in FIG. 15; and

FIG. 17 is an exploded view of the footwear shown in FIG. 15.

### DETAILED DESCRIPTION

Hereinafter, embodiments of the present disclosure will be described in detail with reference to the drawings. In the following embodiments, the same or common parts are denoted by the same reference numerals in the drawings, and the description thereof will not be repeated.

### First Embodiment

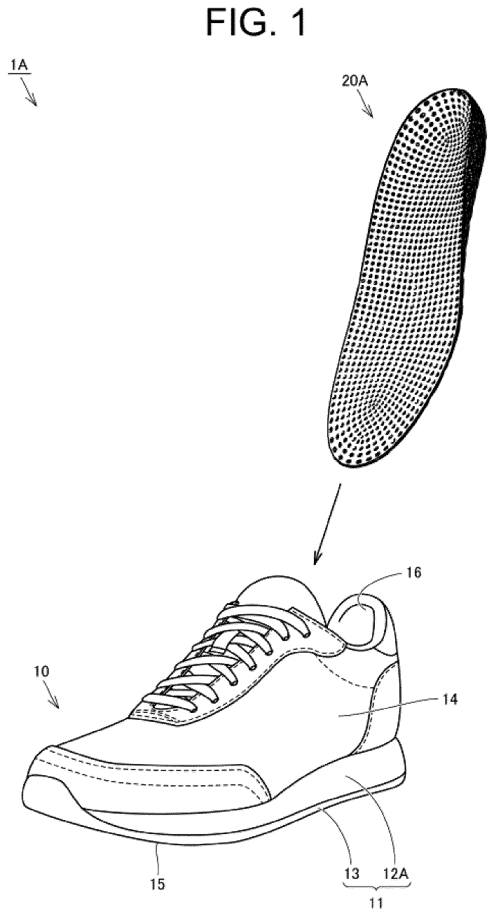

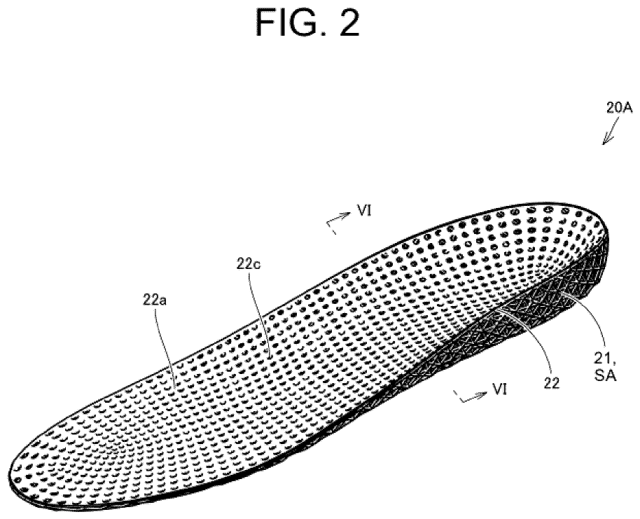

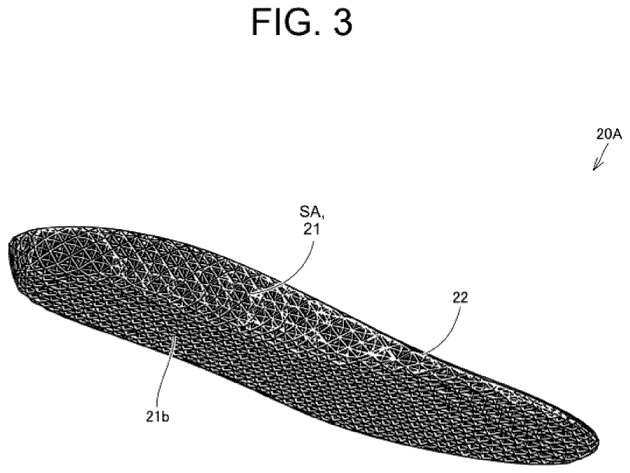

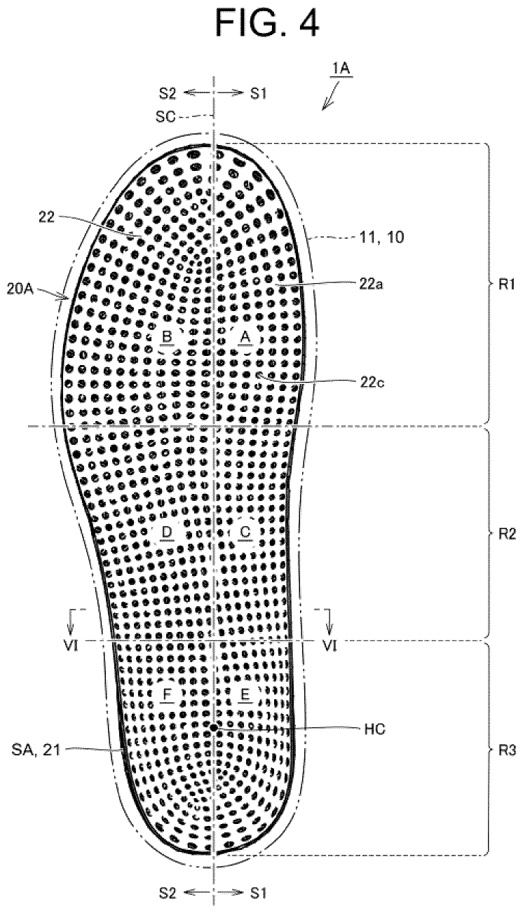

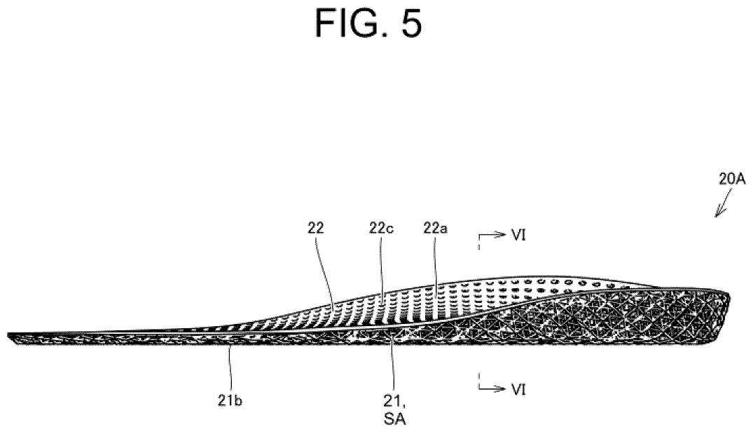

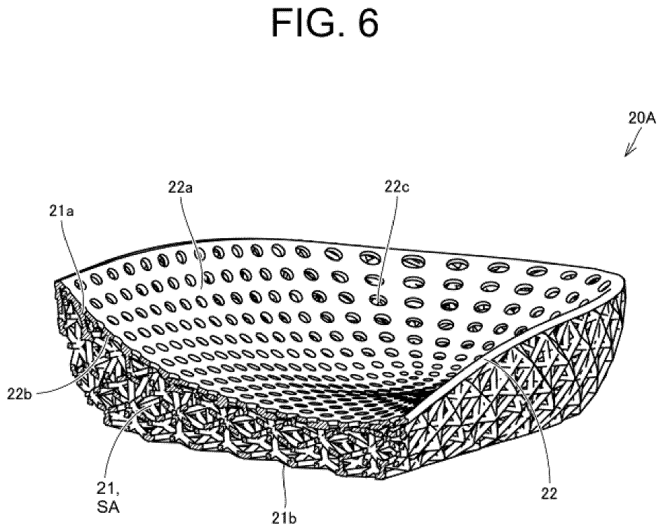

FIG. 1 is an exploded view of footwear according to a first embodiment, and FIGS. 2 and 3 are perspective views of the sockliner shown in FIG. 1 obliquely viewed from the upper right front side and the lower left rear side, respectively. FIG. 4 is a plan view of the sockliner shown in FIG. 1, and FIG. 5 is a side view of the sockliner shown in FIG. 1 viewed from the foot lateral side. FIG. 6 is a partially cut-away perspective view of the sockliner shown in FIG. 1 along the line VI-VI shown in FIGS. 2, 4, and 5, and FIG. 7 is a schematic view for explaining a three-dimensional structure of a base layer portion of the sockliner shown in FIG. 1. First, a schematic configuration of footwear 1A according to the present embodiment and a sockliner 20A included in the footwear 1A will be described with reference to FIGS. 1 to 7.

As shown in FIG. 1, the footwear 1A includes a shoe main body 10 and the sockliner 20A. The shoe main body 10 has a sole 11 and an upper 14 located above the sole 11. The sole 11 has a substantially flat shape, and the upper 14 has a bag-like shape covering a portion of a foot of a wearer excluding the sole of the foot. The sockliner 20A has a substantially flat shape, and is inserted into the inside of the shoe main body 10.

The sole 11 includes a midsole 12A and an outsole 13, and the outsole 13 is fixed to the underside of the midsole 12A by, for example, adhesive bonding or the like. The underside of the outsole 13 constitutes a ground-contacting surface 15, and the midsole 12A is a portion that mainly supports the foot of the wearer. The midsole 12A is preferably excellent in cushioning performance, and may be formed from, for example, a resin foam material. The outsole 13 is preferably excellent in abrasion resistance and grip performance, and may be formed from, for example, a rubber member.

The upper 14 has, in an upper part thereof, a shoe opening 16 through which the foot of the wearer is inserted, and a space into which the foot of the wearer is inserted when worn is formed inside the upper 14. The lower end of the upper 14 is fixed to the topside of the midsole 12A by, for example, adhesive bonding or the like. Woven fabric, knitted fabric, unwoven fabric, a synthetic leather, a resin, or the like is used for the upper 14, for example. In particular, in a shoe required to have air permeability and lightweight, double Raschel warp knitted fabric in which polyester yarn is interweaved is used.

The sockliner 20A is inserted into the shoe main body 10 through the above-described shoe opening 16 provided to the upper 14. Consequently, the sockliner 20A is placed on the inner bottom surface of the shoe main body 10 so that the underside of the sockliner 20A faces the inner bottom surface, whereby the sockliner 20A is mounted in the shoe main body 10. In a state in which the sockliner 20A is mounted in the shoe main body 10, the topside of the sockliner 20A constitutes a support surface that supports the sole of the foot of the wearer.

In a state in which the wearer wears the footwear 1A, the sole 11 as a footbed and the sockliner 20A support the sole of the foot of the wearer. At this time, the sockliner 20A is sandwiched between the sole 11 of the shoe main body 10 and the sole of the foot of the wearer.

As shown in FIGS. 2 to 5, the sockliner 20A has a substantially flat shape, and the outer shape thereof in a plan view substantially matches the outer shape of the inner bottom surface of the shoe main body 10.

The sockliner 20A is formed from a single member, and is constructed from a shaped object produced by three-dimensional additive manufacturing. As the three-dimensional additive manufacturing, stereolithography-type three-dimensional additive manufacturing is adopted, for example.

In FIG. 4, an outer shape line of the shoe main body 10 (that is, an outer shape line of the footwear 1A) in a state where the sockliner 20A is mounted in the shoe main body 10 is indicated by a dash-double-dot line. As illustrated in FIG. 4, the footbed including the sole 11 and the sockliner 20A is divided into a forefoot area R1 that supports a toe portion and a ball portion of the foot of the wearer, a midfoot area R2 that supports an arch portion of the foot of the wearer, and a rearfoot area R3 that supports a heel portion of the foot of the wearer, along the front-rear direction (up-down direction in FIG. 4) that matches a foot length direction of the foot of the wearer in a plan view.

Here, when a front-side end of the footbed is taken as a reference, a position corresponding to a dimension of 40% of the dimension of the footbed in the front-rear direction from the front-side end is defined as a first boundary position, and a position corresponding to a dimension of 70% of the dimension of the footbed in the front-rear direction from the front-side end is defined as a second boundary position, the forefoot area R1 corresponds to a portion included between the front-side end and the first boundary position along the front-rear direction, the midfoot area R2 corresponds to a portion included between the first boundary position and the second boundary position along the front-rear direction, and the rearfoot area R3 corresponds to a portion included between the second boundary position and a rear-side end of the shoe sole along the front-rear direction.

In addition, the footbed is divided, along the left-right direction (the left-right direction shown in FIG. 4) which is a direction matching the width direction of the foot of the wearer in a plan view, into: a portion of the foot on the foot medial side (a portion on the S1 side shown in FIG. 4) which is the median side (that is, the side closer to the median) in the standard anatomical position; and a portion of the foot on the foot lateral side (a portion on the S2 side shown in FIG. 4) which is the opposite side (that is, the side farther from the median) to the median side in the standard anatomical position.

Here, the boundary line that divides the footbed into the portion on the foot medial side and the portion on the foot lateral side is a so-called shoe center SC. The shoe center SC is a straight line obtained, when worn by a standard wearer having a foot size suitable for the footwear 1A, by projecting, onto the footbed along the up-down direction, a straight line connecting a portion between the first toe and the second toe of the wearer and a central portion (so-called heel center (the heel center is indicated by the reference sign HC in FIG. 4, etc.)) of the calcaneus of the wearer. The front-side end and the rear-side end of the footbed described above are end portions of the footbed located on the shoe center SC.

The up-down direction of the sockliner 20A to be described later means a direction matching the thickness direction of the sockliner 20A having a flat shape (that is, the up-down direction in FIG. 5). More specifically, the up-down direction is a direction perpendicular to both the front-rear direction which is a direction matching the foot length direction of the foot of the wearer described above and the left-right direction which is a direction matching the foot width direction of the foot of the wearer described above.

Here, a portion on the foot medial side included in the forefoot area R1 is referred to as the medial forefoot area, which is indicated by the reference sign A in FIG. 4, and a portion on the foot lateral side included in the forefoot area R1 is referred to as the lateral forefoot area, which is indicated by the reference sign B in FIG. 4. Similarly, a portion on the foot medial side included in the midfoot area R2 is referred to as the medial midfoot area, which is indicated by the reference sign C in FIG. 4, and a portion on the foot lateral side included in the midfoot area R2 is referred to as the lateral midfoot area, which is indicated by the reference sign D in FIG. 4. Similarly, a portion on the foot medial side included in the rearfoot area R3 is referred to as the medial rearfoot area, which is indicated by the reference sign E in FIG. 4, and a portion on the foot lateral side included in the rearfoot area R3 is referred to as the lateral rearfoot area, which is indicated by the reference sign F in FIG. 4.

As shown in FIGS. 2 to 6, the sockliner 20A includes a base layer portion 21 and an upper layer portion 22 each configured to form a layer. The base layer portion 21 includes a topside 21a (see FIG. 6 in particular) and an underside 21b, and constitutes a portion on the lower side of the sockliner 20A. The upper layer portion 22 includes a topside 22a and an underside 22b (see FIG. 6 in particular), and covers the topside 21a of the base layer portion 21 to constitute a portion on the upper side of the sockliner 20A. That is, the sockliner 20A has a two-layer structure including the base layer portion 21 and the upper layer portion 22.

As described above, since the sockliner 20A is formed from a single member, the topside 21a of the base layer portion 21 and the underside 22b of the upper layer portion 22 are configured to be continuous with each other. That is, the topside 21a of the base layer portion 21 and the underside 22b of the upper layer portion 22 mean boundary surfaces of the base layer portion 21 and the upper layer portion 22 where a structural difference described later is generated.

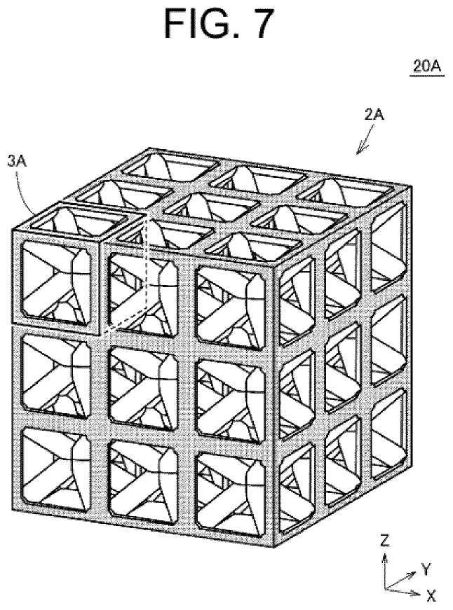

As shown in FIG. 7, the base layer portion 21 is formed from a three-dimensional mesh structure body 2A in which multiple unit structures 3A each having a three-dimensional lattice structure are repeatedly arranged to be adjacent to each other. Here, in the sockliner 20A included in the footwear 1A according to the present embodiment, the unit structures 3A are repeatedly and continuously arranged along three axial directions substantially perpendicular to one another, whereby a large number of holes are provided inside the base layer portion 21 and on the outer surface thereof.

More specifically, the multiple unit structures 3A are repeatedly and continuously arranged in a regular manner along each of the width direction (the X direction shown in the drawing), the depth direction (the Y direction shown in the drawing), and the height direction (the Z direction shown in the drawing). In FIG. 7, only adjacent three-unit structures 3A in each of the width direction, the depth direction, and the height direction are extracted and shown, and cut surfaces thereof are indicated by a dark color.

The unit structure 3A having a three-dimensional lattice structure has a three-dimensional shape in which multiple columns each extending along a predetermined direction are connected to each other. As the unit structure 3A, various structures can be used, and various structures such as a rectangular parallelepiped lattice, a diamond lattice, an octahedral lattice, a double pyramid lattice, a fluorite-type lattice, or a lattice in which various supports are added to these lattices can be applied, for example. The illustrated unit structure 3A is a rectangular parallelepiped lattice to which a central support is added.

In the case where the base layer portion 21 of the sockliner 20A is formed from the three-dimensional mesh structure body 2A as described above, it is preferable that the external shape of the three-dimensional mesh structure body 2A be a shape matching the external shape of the sockliner 20A by distorting the individual unit structures 3A as necessary.

In this way, the outer surface of the sockliner 20A can be formed into a smooth shape.

As shown in FIGS. 2 to 6, by arranging the base layer portion 21 configured as described above in the portion on the lower side of the sockliner 20A, the base layer portion 21 functions as the cushioning portion SA having high deformability. By providing the cushioning portion SA formed from the three-dimensional mesh structure body 2A in the sockliner 20A as described above, the sockliner 20A can have high deformability; therefore, it is possible to provide a sockliner having excellent cushioning performance and good foot comfort, and it is also possible to provide a sockliner having enhanced stability when worn. In addition, since the base layer portion 21 has the above-described configuration, the sockliner can be made light relative to the size thereof, and the sockliner can be further made excellent in air permeability.

The underside 21b of the base layer portion 21 is arranged to face the inner bottom surface of the shoe main body 10 in a state where the sockliner 20A is mounted in the shoe main body 10. Although the underside 21b of the base layer portion 21 has a concavo-convex shape as the above-described large number of holes are provided, the underside 21b is configured to be substantially flat when viewed as a whole. Here, a symbol portion or a design portion such as a character, a logo, a pattern, or an authentication identification code may be further provided on the underside 21b of the base layer portion 21 by shaping as necessary.

On the other hand, as shown in FIGS. 2 to 6, the upper layer portion 22 is formed from a sheet-like structural body. The upper layer portion 22 formed of the sheet-like structural body is provided with multiple holes 22c penetrating the upper layer portion 22 in the thickness direction (that is, the up-down direction of the sockliner 20A). Each of the multiple holes 22c is exposed on the topside 22a of the upper layer portion 22, and faces the base layer portion 21 on the underside 22b of the upper layer portion 22.

Therefore, most of the multiple holes 22c communicate with holes provided inside the base layer portion 21 and on the outer surface thereof at the boundary surface between the upper layer portion 22 and the base layer portion 21.

In addition, a portion corresponding to the forefoot area R1 is configured to have a substantially flat shape, and portions corresponding to the midfoot area R2 and the rearfoot area R3 are configured to have a substantially concave shape so that the topside 22a of the upper layer portion 22 fits the sole of the foot of the wearer. Although the multiple holes 22c are located on the topside 22a of the upper layer portion 22 as described above, the topside 22a has a smooth shape.

By arranging the upper layer portion 22 configured as described above in the portion on the upper side of the sockliner 20A, the base layer portion 21 in which a large number of holes are present inside and on the outer surface and a large number of fine irregularities are thus formed on the topside 21a is covered by the upper layer portion 22, and the topside of the sockliner 20A, which is a portion in contact with the sole of the foot of the user, is constituted by the smoothly formed topside 22a of the upper layer portion 22 formed from the sheet-like structural body, making it possible not only to provide a sockliner with good foot contact and good foot comfort, but also to provide a sockliner with excellent air permeability.

In addition, by arranging the upper layer portion 22 configured as described above in the portion on the upper side of the sockliner 20A, the contact area with the sole of the foot of the wearer is also increased, making it possible to provide a sockliner with enhanced stability when worn, and further to provide a sockliner capable of effectively dispersing foot pressure. Further, since the base layer portion 21 formed from the three-dimensional mesh structure body 2A is protected by the upper layer portion 22, it is possible to provide a sockliner excellent in durability.

The material of the sockliner 20A is not particularly limited, but is preferably a resin material or a rubber material to have appropriate flexibility, stretchability, durability, elastic force, stability, and the like. More specifically, when the sockliner 20A is made of a resin, for example, a polyolefin resin, an ethylene-vinyl acetate copolymer (EVA), a polyamide-based thermoplastic elastomer (TPA, TPAE), a thermoplastic polyurethane (TPU), or a polyester-based thermoplastic elastomer (TPEE) can be used. On the other hand, when the sockliner 20A is made of rubber, for example, butadiene rubber (BR) can be used.

The sockliner 20A can also be formed from a polymer composition. In this case, examples of the polymer contained in the polymer composition include olefin-based polymers such as an olefin-based elastomer and an olefin-based resin. Examples of the olefin-based polymer include polyolefins such as polyethylene (for example, linear low-density polyethylene (LLDPE), high-density polyethylene (HDPE), and the like), polypropylene, an ethylene-propylene copolymer, a propylene-1-hexene copolymer, a propylene-4-methyl-1-pentene copolymer, a propylene-1-butene copolymer, an ethylene-1-hexene copolymer, an ethylene-4-methyl-pentene copolymer, an ethylene-1-butene copolymer, a 1-butene-1-hexene copolymer, and 1-butene-4-methyl-pentene, an ethylene-methacrylic acid copolymer, an ethylene-methyl methacrylate copolymer, an ethylene-ethyl methacrylate copolymer, an ethylene-butyl methacrylate copolymer, an ethylene-methyl acrylate copolymer, an ethylene-ethyl acrylate copolymer, an ethylene-butyl acrylate copolymer, a propylene-methacrylic acid copolymer, a propylene-methyl methacrylate copolymer, a propylene-ethyl methacrylate copolymer, and a propylene-butyl methacrylate copolymer, a propylene-methyl acrylate copolymer, a propylene-ethyl acrylate copolymer, a propylene-butyl acrylate copolymer, an ethylene-vinyl acetate copolymer, and a propylene-vinyl acetate copolymer.

The polymer may be an amide-based polymer such as an amide-based elastomer or an amide-based resin, for example. Examples of the amide-based polymer include polyamide 6, polyamide 11, polyamide 12, polyamide 66, and polyamide 610.

The polymer may be an ester-based polymer such as an ester-based elastomer or an ester-based resin, for example. Examples of the ester-based polymer include polyethylene terephthalate and polybutylene terephthalate.

The polymer may be a urethane-based polymer such as a urethane-based elastomer or a urethane-based resin, for example. Examples of the urethane-based polymer include a polyester-based polyurethane and a polyether-based polyurethane.

The polymer may be a styrene-based polymer such as a styrene-based elastomer or a styrene-based resin, for example. Examples of the styrene-based elastomer include a styrene-ethylene-butylene copolymer (SEB), a styrene-butadiene-styrene copolymer (SBS), a hydrogenated product of a SBS (styrene-ethylene-butylene-styrene copolymer (SEBS)), a styrene-isoprene-styrene copolymer (SIS), a hydrogenated product of a SIS (styrene-ethylene-propylene-styrene copolymer (SEPS)), a styrene-isobutylene-styrene copolymer (SIBS), styrene-butadiene-styrene-butadiene (SBSB), and styrene-butadiene-styrene-butadiene-styrene (SBSBS). Examples of the styrene-based resin include polystyrene, acrylonitrile styrene resin (AS), and acrylonitrile butadiene styrene resin (ABS).

The polymer may be, for example, an acrylic polymer such as polymethyl methacrylate, a urethane-based acrylic polymer, a polyester-based acrylic polymer, a polyether-based acrylic polymer, a polycarbonate-based acrylic polymer, an epoxy-based acrylic polymer, a conjugated diene polymer-based acrylic polymer and a hydrogenated product thereof, a urethane-based methacrylic polymer, a polyester-based methacrylic polymer, a polyether-based methacrylic polymer, a polycarbonate-based methacrylic polymer, a polyester-based urethane acrylate, a polycarbonate-based urethane acrylate, a polyether-based urethane acrylate, an epoxy-based methacrylic polymer, a conjugated diene polymer-based methacrylic polymer and a hydrogenated product thereof, a polyvinyl chloride-based resin, a silicone-based elastomer, butadiene rubber, isoprene rubber (IR), chloroprene rubber (CR), natural rubber (NR), styrene butadiene rubber (SBR), acrylonitrile butadiene rubber (NBR), and butyl rubber (IIR).

As described above, since the sockliner 20A is preferably formed from a flexible material, it is particularly preferable that the sockliner 20A be formed from urethane acrylate among the above-described materials. When the sockliner 20A is formed from urethane acrylate, not only excellent durability and stretchability are obtained, but also sufficient elastic force is obtained. As described above, since the sockliner 20A is produced by, for example, stereolithography-type three-dimensional additive manufacturing, the sockliner 20A may include a curing agent as an auxiliary component.

Note that, for the footwear 1A according to the present embodiment, a case where the sockliner 20A is configured to include: the base layer portion 21 including the cushioning portion SA formed from the three-dimensional mesh structure body 2A; and the upper layer portion 22 formed from the sheet structural body covering the base layer portion 21 is exemplified. However, the upper layer portion 22 is not necessarily provided, and the sockliner 20A may be configured to include only the base layer portion 21 including the cushioning portion SA formed from the three-dimensional mesh structure body 2A.

As described above, in the footwear 1A according to the present embodiment, the cushioning portion SA formed from the three-dimensional mesh structure body 2A is included in the sockliner 20A which is placed on the sole 11 of the shoe main body 10 and used. Since the cushioning portion SA can be produced by three-dimensional additive manufacturing as described above, various structural improvements can be made to the sockliner 20A because of the high degree of freedom of design thereof. In this regard, in the footwear 1A according to the present embodiment, the sockliner 20 can be configured as in, for example, sockliners 20A1 to 20A3 according to first to third configuration examples described below depending on the use of the footwear 1A.

Here, the occupied volume ratio in the cushioning portion SA, which will be described later, represents a ratio of a volume of a solid portion (that is, a portion other than the above-described holes (hollow portion)) per a predetermined volume of the three-dimensional mesh structure body 2A. A portion with a large occupied volume ratio has high rigidity, and a portion with a small occupied volume ratio has low rigidity, in general. Although a specific magnitude of the occupied volume ratio in the cushioning portion SA is not particularly limited, the occupied volume ratio is approximately 5% or more and 80% or less, the occupied volume ratio is approximately 30% or more (in some cases, 35% or more) in a portion to which high rigidity is imparted, and the occupied volume ratio is approximately less than 30% (in some cases, 25% or less) in a portion to which low rigidity is imparted.

As a method of making the occupied volume ratio in the cushioning portion SA different for each portion as described later, for example, it is considered that the size of the unit structure 3A described above is changed for each portion of the cushioning portion SA, the thickness of the pillars of the unit structure 3A is changed for each portion of the cushioning portion SA, or the structure itself of the unit structure 3A is changed for each portion of the cushioning portion SA. Among them, in order to make the occupied volume ratio of the cushioning portion SA different for each portion without deteriorating the foot contact, it is particularly effective to configure the cushioning portion SA so that the size of the unit structure 3A gradually changes.

Incidentally, a method of calculating the occupied volume ratio is as follows: the specific gravity of the material forming the three-dimensional mesh structure body 2A is measured, portions corresponding to the medial forefoot area, the lateral forefoot area, the medial midfoot area, the lateral midfoot area, the medial rearfoot area, and the lateral rearfoot area in the present disclosure are cut out from the three-dimensional mesh structure body 2A, the volumes (including the above-described solid portions and hollow portions) and weights of the respective cut-out portions are measured, and each occupied volume ratio can be calculated from the specific gravity, the volume, and the weight.

### First Configuration Example

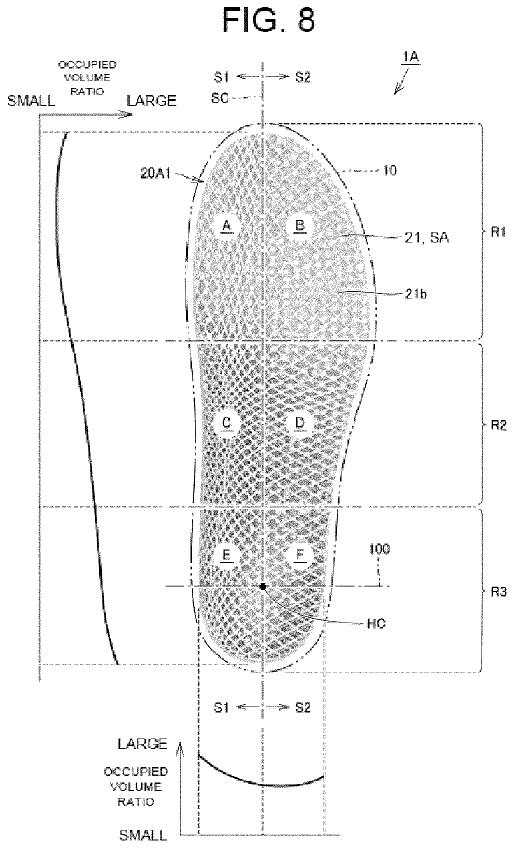

FIG. 8 is a schematic bottom view for explaining occupied volume ratio distribution of a sockliner according to a first configuration example. Hereinafter, a sockliner 20A1 according to the first configuration example will be described with reference to FIG. 8. Incidentally, the footwear 1A provided with the sockliner 20A1 is running shoes intended for heel strike running or midfoot strike running, for example.

Running shoes intended for heel strike running or midfoot strike running are particularly required to impart high stability to a portion on the foot medial side of the foot of the wearer at landing, from the viewpoint of preventing so-called overpronation; and to have an excellent function to support a portion from the heel portion to the medial and lateral longitudinal arches of the foot of the wearer, from the viewpoint of preventing fatigue accumulation and injury associated with heel striking.

In order to make it possible to impart high stability to the portion on the foot medial side of the foot of the wearer at landing, it is effective to increase the rigidity of a portion of the footbed on the foot medial side to be higher than the rigidity of a portion on the foot lateral side of the footbed. In order to achieve an excellent function to support the portion from the heel portion to the medial and lateral longitudinal arches of the foot of the wearer, it is effective to increase the rigidity of the midfoot area R2 and the rearfoot area R3 of the footbed.

In this regard, as shown in FIG. 8, in the sockliner 20A1 according to the first configuration example, the cushioning portion SA formed from the three-dimensional mesh structure body 2A is configured to satisfy the following conditions 1-1 to 1-7.

Condition 1-1: the occupied volume ratio of the cushioning portion SA in the portion located in the medial forefoot area A is larger than the occupied volume ratio of the cushioning portion SA in the portion located in the lateral forefoot area B.

Condition 1-2: the occupied volume ratio of the cushioning portion SA in the portion located in the medial midfoot area C is larger than the occupied volume ratio of the cushioning portion SA in the portion located in the lateral midfoot area D.

Condition 1-3: the occupied volume ratio of the cushioning portion SA in the portion located in the medial rearfoot area E is larger than the occupied volume ratio of the cushioning portion SA in the portion located in the lateral rearfoot area F.

Condition 1-4: the occupied volume ratio of the cushioning portion SA in the portion located in the medial forefoot area A is smaller than the occupied volume ratio of the cushioning portion SA in the portion located in the medial midfoot area C.

Condition 1-5: the occupied volume ratio of the cushioning portion SA in the portion located in the lateral forefoot area B is smaller than the occupied volume ratio of the cushioning portion SA in the portion located in the lateral midfoot area D.

Condition 1-6: the occupied volume ratio of the cushioning portion SA in the portion located in the medial midfoot area C is equal to or smaller than the occupied volume ratio of the cushioning portion SA in the portion located in the medial rearfoot area E.

Condition 1-7: the occupied volume ratio of the cushioning portion SA in the portion located in the lateral midfoot area D is equal to or smaller than the occupied volume ratio of the cushioning portion SA in the portion located in the lateral rearfoot area F.

In FIG. 8, the occupied volume ratio distribution of a portion along the shoe center SC is represented by the graph on the left side of the drawing, and the occupied volume ratio distribution of a portion along a line 100, which is perpendicular to the shoe center SC and passes the heel center HC, shown in the drawing is represented by the graph on the lower side of the drawing.

When the cushioning portion SA is configured to satisfy the conditions 1-1 to 1-3 among the above conditions, it is possible to increase the rigidity of the portion on the foot medial side of the footbed to be higher than the rigidity of the portion on the foot lateral side. Therefore, when the footwear 1A is configured to satisfy the conditions 1-1 to 1-3, it is possible to provide footwear capable of imparting high stability to the portion on the foot medial side of the foot of the wearer at landing.

In addition, when the cushioning portion SA is configured to satisfy the conditions 1-4 to 1-7 among the above conditions, it is possible to increase the rigidity of the midfoot area R2 and the rearfoot area R3 to be higher than the rigidity of the forefoot area R1 of the footbed, and it is possible to make the rigidity of the rearfoot area R3 of the footbed to be equal to or higher than the rigidity of the midfoot area R2. Therefore, when the footwear 1A is configured to satisfy the conditions 1-4 to 1-7, it is possible to provide footwear capable of achieving an excellent function to support a portion from the heel portion to the medial and lateral longitudinal arches of the foot of the wearer.

Accordingly, when the footwear 1A is configured to satisfy the conditions 1-1 to 1-7, it is possible to provide footwear especially suitable for heel strike running or midfoot strike running.

Here, in a case where a clear difference in function is provided by the midfoot area R2 and the rearfoot area R3, the occupied volume ratio of the cushioning portion SA in the portion located in the medial midfoot area C may be made smaller than the occupied volume ratio of the cushioning portion SA in the portion located in the medial rearfoot area E, and the occupied volume ratio of the cushioning portion SA in the portion located in the lateral midfoot area D may be made smaller than the occupied volume ratio of the cushioning portion SA in the portion located in the lateral rearfoot area F.

From the viewpoint of preventing deterioration of foot contact, a configuration in which large changes in the rigidity of the cushioning portion SA do not occur locally is preferable. For this purpose, it is preferable to configure the cushioning portion SA so that the occupied volume ratio gradually changes as represented by the graphs shown in FIG. 8. In addition, from the viewpoint of improving the fit to the foot of the wearer and enabling stable support, as represented by the graphs shown in FIG. 8, it is preferable to increase the rigidity of the peripheral edge portion of the cushioning portion SA.

### Second Configuration Example

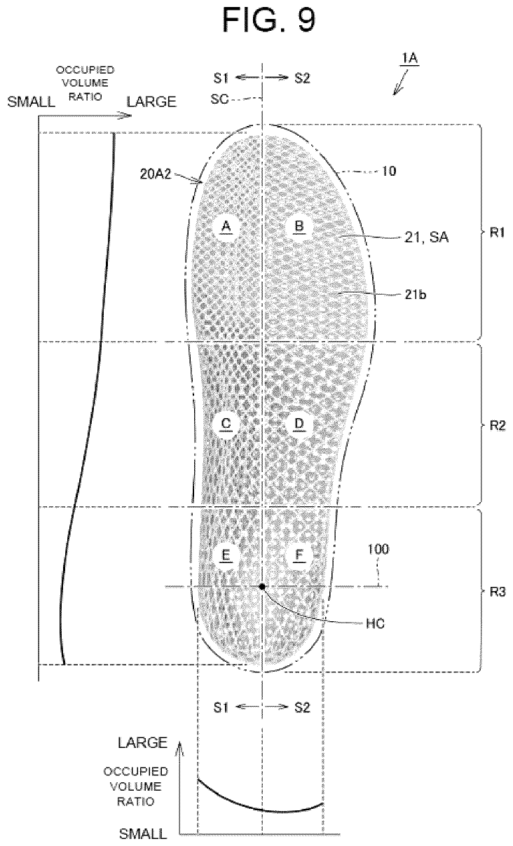

FIG. 9 is a schematic bottom view for explaining occupied volume ratio distribution of a sockliner according to a second configuration example. Hereinafter, a sockliner 20A2 according to the second configuration example will be described with reference to FIG. 9. Incidentally, the footwear 1A provided with the sockliner 20A2 is running shoes intended for forefoot strike running, for example.

Running shoes intended for forefoot strike running are particularly required to provide high stability to the portion on the foot medial side of the foot of the wearer at landing, from the viewpoint of preventing so-called overpronation; to have a function to efficiently transmit, to the ground, the toe-off force from the toe portion of the foot of the wearer, from the viewpoint of improving propulsion during toe-off; to have an excellent function to support the medial and lateral longitudinal arches of the foot of the wearer, from the viewpoint of preventing fatigue accumulation and injury; and to impart high cushioning performance for the heel portion of the foot of the wearer at landing, from the viewpoint of shock relaxation.

In order to make it possible to impart high stability to the portion on the foot medial side of the foot of the wearer at landing, it is effective to increase the rigidity of a portion on the foot medial side of the footbed to be higher than the rigidity of a portion on the foot lateral side. In order to achieve an excellent function to support the medial and lateral longitudinal arches of the foot of the wearer, while achieving the function to efficiently transmit, to the ground, the toe-off force from the toe portion of the foot of the wearer, it is effective to increase the rigidity of the forefoot area R1 and the midfoot area R2 of the footbed. In order to make it possible to impart high cushioning performance for the heel portion of the foot of the wearer at landing, it is effective to increase the rigidity of the rearfoot area R3 to be not extremely higher than the rigidity of the forefoot area R1 and the midfoot area R2 of the footbed.

In this regard, as shown in FIG. 9, in the sockliner 20A2 according to the second configuration example, the cushioning portion SA formed from the three-dimensional mesh structure body 2A is configured to satisfy the following conditions 2-1 to 2-7.

Condition 2-1: the occupied volume ratio of the cushioning portion SA in the portion located in the medial forefoot area A is larger than the occupied volume ratio of the cushioning portion SA in the portion located in the lateral forefoot area B.

Condition 2-2: the occupied volume ratio of the cushioning portion SA in the portion located in the medial midfoot area C is larger than the occupied volume ratio of the cushioning portion SA in the portion located in the lateral midfoot area D.

Condition 2-3: the occupied volume ratio of the cushioning portion SA in the portion located in the medial rearfoot area E is larger than the occupied volume ratio of the cushioning portion SA in the portion located in the lateral rearfoot area F.

Condition 2-4: the occupied volume ratio of the cushioning portion SA in the portion located in the medial forefoot area A is equal to or larger than the occupied volume ratio of the cushioning portion SA in the portion located in the medial midfoot area C.

Condition 2-5: the occupied volume ratio of the cushioning portion SA in the portion located in the lateral forefoot area B is equal to or larger than the occupied volume ratio of the cushioning portion SA in the portion located in the lateral midfoot area D.

Condition 2-6: the occupied volume ratio of the cushioning portion SA in the portion located in the medial midfoot area C is larger than the occupied volume ratio of the cushioning portion SA in the portion located in the medial rearfoot area E.

Condition 2-7: the occupied volume ratio of the cushioning portion SA in the portion located in the lateral midfoot area D is larger than the occupied volume ratio of the cushioning portion SA in the portion located in the lateral rearfoot area F.

In FIG. 9, the occupied volume ratio distribution of a portion along the shoe center SC is represented by the graph on the left side of the drawing, and the occupied volume ratio distribution of a portion along a line 100, which is perpendicular to the shoe center SC and passes the heel center HC, shown in the drawing is represented by the graph on the lower side of the drawing.

When the cushioning portion SA is configured to satisfy the conditions 2-1 to 2-3 among the above conditions, it is possible to increase the rigidity of the portion on the foot medial side of the footbed to be higher than the rigidity of the portion on the foot lateral side. Therefore, when the footwear 1A is configured to satisfy the conditions 2-1 to 2-3, it is possible to provide footwear capable of imparting high stability to the portion on the foot medial side of the foot of the wearer at landing.

In addition, when the cushioning portion SA is configured to satisfy the conditions 2-4 to 2-7 among the above conditions, it is possible to increase the rigidity of the forefoot area R1 and the midfoot area R2 of the footbed, and it is possible to increase the rigidity of the rearfoot area R3 to be not extremely higher than the rigidity of the forefoot area R1 and the midfoot area R2 of the footbed. Therefore, when the footwear 1A is configured to satisfy the conditions 2-4 to 2-7, it is possible to provide footwear achieving the function to efficiently transmit, to the ground, the toe-off force from the toe portion of the foot of the wearer, and capable of imparting high cushioning performance for the heel portion of the foot of the wearer at landing, while achieving the excellent function to support the medial and lateral longitudinal arches of the foot of the wearer.

Accordingly, when the footwear 1A is configured to satisfy the conditions 2-1 to 2-7, it is possible to provide footwear especially suitable for forefoot strike running.

Here, in a case where a clear difference in function is provided by the forefoot area R1 and the midfoot area R2, the occupied volume ratio of the cushioning portion SA in the portion located in the medial forefoot area A may be made larger than the occupied volume ratio of the cushioning portion SA in the portion located in the medial midfoot area C, and the occupied volume ratio of the cushioning portion SA in the portion located in the lateral forefoot area B may be made larger than the occupied volume ratio of the cushioning portion SA in the portion located in the lateral midfoot area D.

From the viewpoint of preventing deterioration of foot contact, a configuration in which large changes in the rigidity of the cushioning portion SA do not occur locally is preferable. For this purpose, it is preferable to configure the cushioning portion SA so that the occupied volume ratio gradually changes as represented by the graphs shown in FIG. 9. In addition, from the viewpoint of improving the fit to the foot of the wearer and enabling stable support, as represented by the graphs shown in FIG. 9, it is preferable to increase the rigidity of the peripheral edge portion of the cushioning portion SA.

### Third Configuration Example

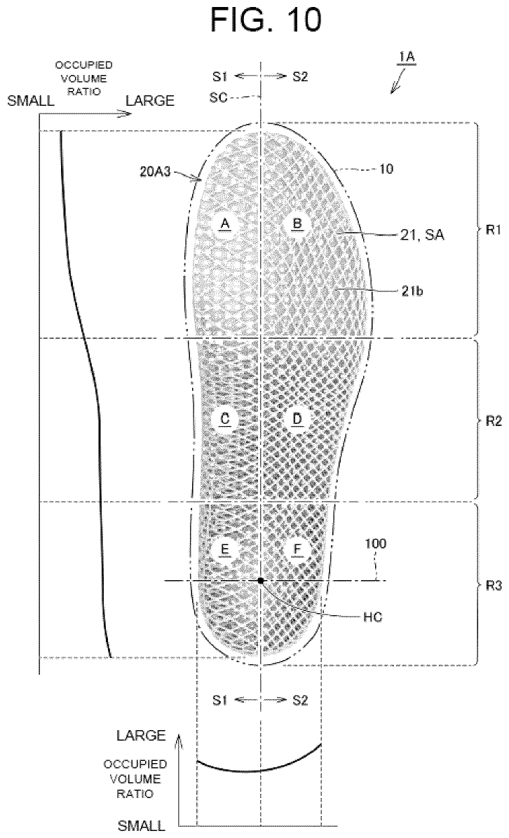

FIG. 10 is a schematic bottom view for explaining occupied volume ratio distribution of a sockliner according to a third configuration example. Hereinafter, a sockliner 20A3 according to the third configuration example will be described with reference to FIG. 10. Incidentally, the footwear 1A provided with the sockliner 20A3 is shoes intended for use in specific ball sports typified by tennis.

Shoes used for specific ball sports typified by tennis are particularly required to provide high stability to a portion on the foot lateral side of the foot of the wearer during turning motions, because many cutting movements are involved; and to have an excellent function to support a portion from the heel portion to the medial and lateral longitudinal arches of the foot of the wearer, from the viewpoint of preventing fatigue accumulation and injury associated with heel striking.

In order to make it possible to impart high stability to the portion on the foot lateral side of the foot of the wearer during turning motions, it is effective to increase the rigidity of a portion of the footbed on the foot lateral side to be higher than the rigidity of a portion on the foot medial side. In order to achieve an excellent function to support a portion from the heel portion to the medial and lateral longitudinal arches of the foot of the wearer, it is effective to increase the rigidity of the midfoot area R2 and the rearfoot area R3 of the footbed.

In this regard, as shown in FIG. 10, in the sockliner 20A3 according to the third configuration example, the cushioning portion SA formed from the three-dimensional mesh structure body 2A is configured to satisfy the following conditions 3-1 to 3-7.

Condition 3-1: the occupied volume ratio of the cushioning portion SA in the portion located in the medial forefoot area A is smaller than the occupied volume ratio of the cushioning portion SA in the portion located in the lateral forefoot area B.

Condition 3-2: the occupied volume ratio of the cushioning portion SA in the portion located in the medial midfoot area C is smaller than the occupied volume ratio of the cushioning portion SA in the portion located in the lateral midfoot area D.

Condition 3-3: the occupied volume ratio of the cushioning portion SA in the portion located in the medial rearfoot area E is smaller than the occupied volume ratio of the cushioning portion SA in the portion located in the lateral rearfoot area F.

Condition 3-4: the occupied volume ratio of the cushioning portion SA in the portion located in the medial forefoot area A is smaller than the occupied volume ratio of the cushioning portion SA in the portion located in the medial midfoot area C.

Condition 3-5: the occupied volume ratio of the cushioning portion SA in the portion located in the lateral forefoot area B is smaller than the occupied volume ratio of the cushioning portion SA in the portion located in the lateral midfoot area D.

Condition 3-6: the occupied volume ratio of the cushioning portion SA in the portion located in the medial midfoot area C is equal to or smaller than the occupied volume ratio of the cushioning portion SA in the portion located in the medial rearfoot area E.

Condition 3-7: the occupied volume ratio of the cushioning portion SA in the portion located in the lateral midfoot area D is equal to or smaller than the occupied volume ratio of the cushioning portion SA in the portion located in the lateral rearfoot area F.

In FIG. 10, the occupied volume ratio distribution of a portion along the shoe center SC is represented by the graph on the left side of the drawing, and the occupied volume ratio distribution of a portion along a line 100, which is perpendicular to the shoe center SC and passes the heel center HC, shown in the drawing is represented by the graph on the lower side of the drawing.

When the cushioning portion SA is configured to satisfy the conditions 3-1 to 3-3 among the above conditions, it is possible to increase the rigidity of the portion on the foot lateral side of the footbed to be higher than the rigidity of the portion on the foot medial side. Therefore, when the footwear 1A is configured to satisfy the conditions 3-1 to 3-3, it is possible to provide footwear capable of imparting high stability to the portion on the lateral foot side of the foot of the wearer during turning motions.

In addition, when the cushioning portion SA is configured to satisfy the conditions 3-4 to 3-7 among the above conditions, it is possible to increase the rigidity of the midfoot area R2 and the rearfoot area R3 to be higher than the rigidity of the forefoot area R1 of the footbed, and it is possible to make the rigidity of the rearfoot area R3 of the footbed to be equal to or higher than the rigidity of the midfoot area R2.

Therefore, when the footwear 1A is configured to satisfy the conditions 3-4 to 3-7, it is possible to provide footwear capable of achieving an excellent function to support a portion from the heel portion to the medial and lateral longitudinal arches of the foot of the wearer.

Accordingly, when the footwear 1A is configured to satisfy the conditions 3-1 to 3-7, it is possible to provide footwear especially suitable for specific ball sports typified by tennis involving many cutting movements and involving frequent heel striking.

Here, in a case where a clear difference in function is provided by the midfoot area R2 and the rearfoot area R3, the occupied volume ratio of the cushioning portion SA in the portion located in the medial midfoot area C may be made smaller than the occupied volume ratio of the cushioning portion SA in the portion located in the medial rearfoot area E, and the occupied volume ratio of the cushioning portion SA in the portion located in the lateral midfoot area D may be made smaller than the occupied volume ratio of the cushioning portion SA in the portion located in the lateral rearfoot area F.

From the viewpoint of preventing deterioration of foot contact, a configuration in which large changes in the rigidity of the cushioning portion SA do not occur locally is preferable. For this purpose, it is preferable to configure the cushioning portion SA so that the occupied volume ratio gradually changes as represented by the graphs shown in FIG. 10.

In addition, from the viewpoint of improving the fit to the foot of the wearer and enabling stable support, as represented by the graphs shown in FIG. 10, it is preferable to increase the rigidity of the peripheral edge portion of the cushioning portion SA.

### Fourth Configuration Example

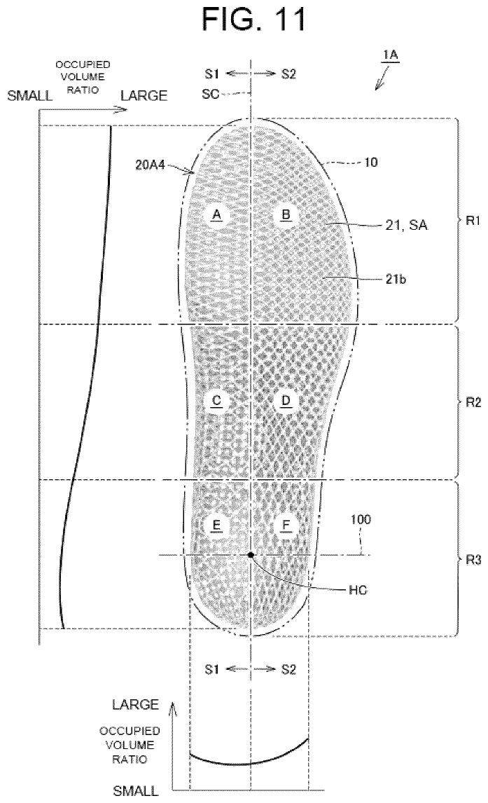

FIG. 11 is a schematic bottom view for explaining occupied volume ratio distribution of a sockliner according to a fourth configuration example.

Hereinafter, a sockliner 20A4 according to the fourth configuration example will be described with reference to FIG. 11. Incidentally, the footwear 1A provided with the sockliner 20A4 is shoes intended for use in specific ball sports typified by table tennis and basketball.

Shoes used for specific ball sports typified by table tennis and basketball are particularly required to provide high stability to a portion on the lateral foot side of the foot of the wearer during cutting movements, because many cutting movements are involved; and to provide a function to efficiently transmit, to the ground, the toe-off force from the toe portion and the ball portion of the foot of the wearer, from the viewpoint of improving propulsion during toe-off.

In order to make it possible to impart high stability to a portion on the foot lateral side of the foot of the wearer during turning motions, it is effective to increase the rigidity of a portion on the foot lateral side of the footbed to be higher than the rigidity of a portion on the foot medial side. In order to achieve the function to efficiently transmit, to the ground, the toe-off force from the toe portion and the ball portion of the foot of the wearer, it is effective to increase the rigidity of the forefoot area R1 and the midfoot area R2 of the footbed.

In this regard, as shown in FIG. 11, in the sockliner 20A4 according to the fourth configuration example, the cushioning portion SA formed from the three-dimensional mesh structure body 2A is configured to satisfy the following conditions 4-1 to 4-7.

Condition 4-1: the occupied volume ratio of the cushioning portion SA in the portion located in the medial forefoot area A is smaller than the occupied volume ratio of the cushioning portion SA in the portion located in the lateral forefoot area B.

Condition 4-2: the occupied volume ratio of the cushioning portion SA in the portion located in the medial midfoot area C is smaller than the occupied volume ratio of the cushioning portion SA in the portion located in the lateral midfoot area D.

Condition 4-3: the occupied volume ratio of the cushioning portion SA in the portion located in the medial rearfoot area E is smaller than the occupied volume ratio of the cushioning portion SA in the portion located in the lateral rearfoot area F.

Condition 4-4: the occupied volume ratio of the cushioning portion SA in the portion located in the medial forefoot area A is equal to or larger than the occupied volume ratio of the cushioning portion SA in the portion located in the medial midfoot area C.

Condition 4-5: the occupied volume ratio of the cushioning portion SA in the portion located in the lateral forefoot area B is equal to or larger than the occupied volume ratio of the cushioning portion SA in the portion located in the lateral midfoot area D.

Condition 4-6: the occupied volume ratio of the cushioning portion SA in the portion located in the medial midfoot area C is larger than the occupied volume ratio of the cushioning portion SA in the portion located in the medial rearfoot area E.

Condition 4-7: the occupied volume ratio of the cushioning portion SA in the portion located in the lateral midfoot area D is larger than the occupied volume ratio of the cushioning portion SA in the portion located in the lateral rearfoot area F.

In FIG. 11, the occupied volume ratio distribution of a portion along the shoe center SC is represented by the graph on the left side of the drawing, and the occupied volume ratio distribution of a portion along a line 100, which is perpendicular to the shoe center SC and passes the heel center HC, shown in the drawing is represented by the graph on the lower side of the drawing.

When the cushioning portion SA is configured to satisfy the conditions 4-1 to 4-3 among the above conditions, it is possible to increase the rigidity of the portion on the foot lateral side of the footbed to be higher than the rigidity of the portion on the foot medial side. Therefore, when the footwear 1A is configured to satisfy the conditions 4-1 to 4-3, it is possible to provide footwear capable of imparting high stability to the portion on the lateral foot side of the foot of the wearer during turning motions.

In addition, when the cushioning portion SA is configured to satisfy the conditions 4-4 to 4-7 among the above conditions, it is possible to make the rigidity of the forefoot area R1 of the footbed to be equal to or higher than the rigidity of the midfoot area R2, and it is possible to increase the rigidity of the midfoot area R2 of the footbed to be higher than the rigidity of the rearfoot area R3. Therefore, when the footwear 1A is configured to satisfy the conditions 4-4 to 4-7, it is possible to provide footwear achieving the function to efficiently transmit, to the ground, the toe-off force from the toe portion and the ball portion of the foot of the wearer.

Accordingly, when the footwear 1A is configured to satisfy the conditions 4-1 to 4-7, it is possible to provide footwear especially suitable for specific ball sports typified by table tennis and basketball involving many cutting movements and requiring exercise of toe-off force from the toe portion and the ball portion.

Here, in a case where a clear difference in function is provided by the forefoot area R1 and the midfoot area R2, the occupied volume ratio of the cushioning portion SA in the portion located in the medial forefoot area A may be made larger than the occupied volume ratio of the cushioning portion SA in the portion located in the medial midfoot area C, and the occupied volume ratio of the cushioning portion SA in the portion located in the lateral forefoot area B may be made larger than the occupied volume ratio of the cushioning portion SA in the portion located in the lateral midfoot area D.

From the viewpoint of preventing deterioration of foot contact, a configuration in which large changes in the rigidity of the cushioning portion SA do not occur locally is preferable. For this purpose, it is preferable to configure the cushioning portion SA so that the occupied volume ratio gradually changes as represented by the graphs shown in FIG. 11.

In addition, from the viewpoint of improving the fit to the foot of the wearer and enabling stable support, as represented by the graphs shown in FIG. 11, it is preferable to increase the rigidity of the peripheral edge portion of the cushioning portion SA.

As described above, the footwear 1A configured according to the present embodiment can provide footwear having a function more suitable for intended use.

Note that the occupied volume ratio distribution in the thickness direction of the cushioning portion SA is assumed to be either the following first embodiment or second embodiment.

In the first embodiment, the occupied volume ratio in a portion of the cushioning portion SA on the ground-contacting surface 15 side (that is, the lower side) is made larger than the occupied volume ratio in a portion of the cushioning portion SA on the side (that is, the upper side) opposed to the ground-contacting surface 15 side. In such a configuration, since the portion of the cushioning portion SA on the lower side has high hardness, and the portion of the cushioning portion SA on the upper side has low hardness, the strength of the cushioning portion SA on the ground-contacting surface 15 side is increased to improve durability.

In the second embodiment, the occupied volume ratio in a portion of the cushioning portion SA on the ground-contacting surface 15 side (that is, the lower side) is made smaller than the occupied volume ratio in a portion of the cushioning portion SA on the side (that is, the upper side) opposed to the ground-contacting surface 15 side. In such a configuration, since the portion of the cushioning portion SA on the lower side has low hardness, and the portion of the cushioning portion SA on the upper side has high hardness, deformability of the cushioning portion SA is improved to enhance cushioning performance.

### <First Modification>

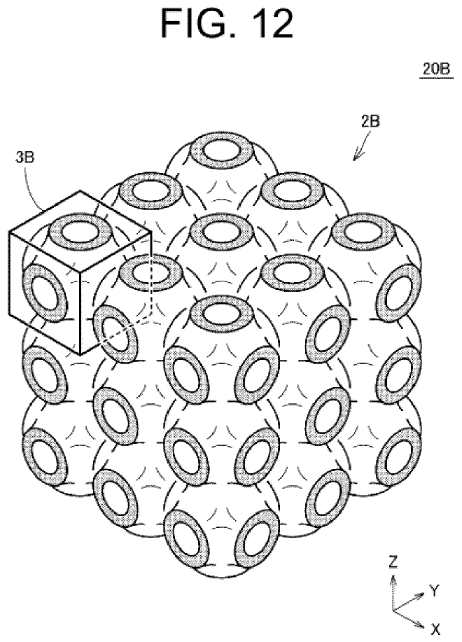

FIG. 12 is a schematic view for explaining a three-dimensional structure of a base layer portion of a sockliner included in footwear according to a first modification. Hereinafter, a sockliner 20B included in the footwear according to the first modification based on the first embodiment described above will be described with reference to FIG. 12.

The configuration of the sockliner 20B included in the footwear according to the first modification differs only in the point that the base layer portion 21 has a different three-dimensional structure when compared with the sockliner 20A included in the footwear 1A according to the first embodiment described above.

Specifically, as shown in FIG. 12, the base layer portion 21 of the sockliner 20B included in the footwear according to the first modification is formed from a three-dimensional mesh structure body 2B in which multiple unit structures 3B having a three-dimensional wall structure are repeatedly arranged to be adjacent to each other. More specifically, the multiple unit structures 3B are repeatedly and continuously arranged in a regular manner along each of the width direction (X direction shown in the drawing), the depth direction (Y direction shown in the drawing), and the height direction (Z direction shown in the drawing). In FIG. 12, only adjacent three unit structures 3B in each of the width direction, the depth direction, and the height direction are extracted and shown, and cut surfaces thereof are indicated by a dark color.

The unit structure 3B having a three-dimensional wall structure has a three-dimensional shape formed by a wall, the outer shape of which is defined by a pair of curved surfaces parallel to each other. Here, the illustrated unit structure 3B is based on the Schwarz P structure, which is a kind of mathematically defined triply periodic minimal surface, with a thickness added thereto. Incidentally, the minimal surface is defined as a curved surface having the smallest area among curved surfaces bounded by a given closed curve.

When the cushioning portion SA formed from the three-dimensional mesh structure body 2B is configured to satisfy the conditions 1-1 to 1-7 described in the first configuration example described above, the conditions 2-1 to 2-7 described in the second configuration example described above, the conditions 3-1 to 3-7 described in the third configuration example described above, or the conditions 4-1 to 4-7 described in the fourth configuration example described above, it is possible to provide footwear having a function more suitable for intended use, also in the sockliner 20B included in the footwear according to the first modification.

Incidentally, a structure based on another triply periodic minimal surfaces such as the gyroid structure or the Schwarz D structure, with a thickness added thereto can also be utilized, for example, as the unit structure 3B formed from a three-dimensional wall structure having a three-dimensional shape formed by a wall, the outer shape of which is defined by a pair of curved surfaces parallel to each other.

### <Second Modification>

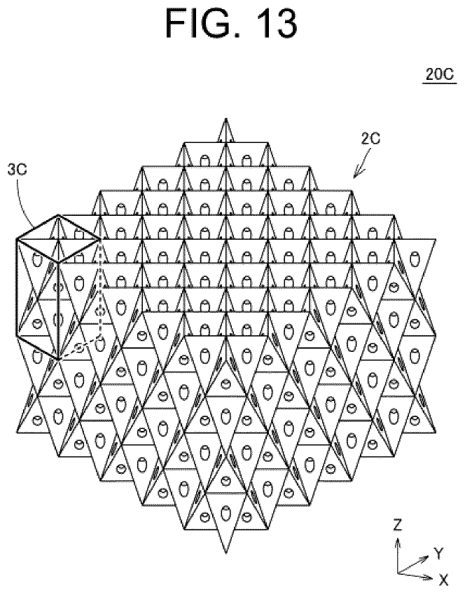

FIG. 13 is a schematic view for explaining a three-dimensional structure of a base layer portion of a sockliner included in footwear according to a second modification. Hereinafter, a sockliner 20C included in the footwear according to the second modification based on the first embodiment described above will be described with reference to FIG. 13.

The configuration of the sockliner 20C included in the footwear according to the second modification differs only in the point that the base layer portion 21 has a different three-dimensional structure when compared with the sockliner 20A included in the footwear 1A according to the first embodiment described above.

Specifically, as shown in FIG. 13, the base layer portion 21 of the sockliner 20C included in the footwear according to the second modification is formed from a three-dimensional mesh structure 2C in which multiple unit structures 3C having a three-dimensional wall structure are repeatedly arranged to be adjacent to each other. More specifically, the multiple unit structures 3C are repeatedly and continuously arranged in a regular manner along each of the width direction (X direction shown in the drawing), the depth direction (Y direction shown in the drawing), and the height direction (Z direction shown in the drawing). In FIG. 13, only adjacent five-unit structures 3C in each of the width direction and the depth direction, and only adjacent two-unit structures 3C in the height direction are extracted and shown.

The unit structure 3B having a three-dimensional wall structure has a three-dimensional shape formed by a wall, the outer shape of which is defined by a pair of flat surfaces parallel to each other. Here, the illustrated unit structure 3C is based on multiple planes arranged to intersect with one another and to have a cavity therein, with a thickness added to the planes, and is specifically an octet structure with a thickness added thereto.

When the cushioning portion SA formed from the three-dimensional mesh structure 2C is configured to satisfy the conditions 1-1 to 1-7 described in the first configuration example described above, the conditions 2-1 to 2-7 described in the second configuration example described above, the conditions 3-1 to 3-7 described in the third configuration example described above, or the conditions 4-1 to 4-7 described in the fourth configuration example described above, it is possible to provide footwear having a function more suitable for intended use, also in the sockliner 20C included in the footwear according to the second modification.

Incidentally, a structure based on another type of multiple planes arranged to intersect with each other and to have a cavity therein, which is typified by a cubic structure, cubic octet structure, and the like, with a thickness added thereto can also be utilized as the unit structure 3C formed from a three-dimensional wall structure having a three-dimensional shape formed by a wall, the outer shape of which is defined by a pair of flat surfaces parallel to each other.

### Second Embodiment

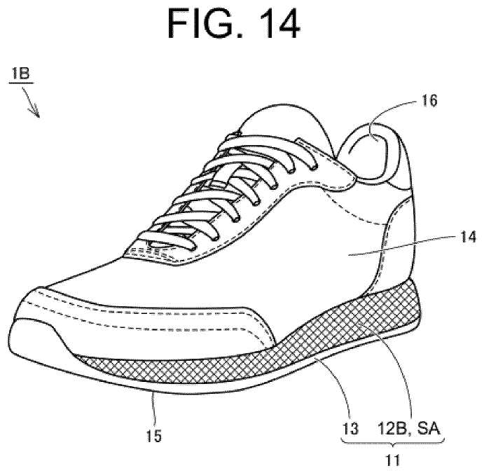

FIG. 14 is a perspective view of footwear according to a second embodiment. Hereinafter, footwear 1B according to the present embodiment will be described with reference to FIG. 14.

As show in FIG. 14, the footwear 1B includes a sole 11 as the footbed, and an upper 14 located above the sole 11, and the sole 11 includes a sole main body 12B and an outsole 13. The sole main body 12B is included in the footwear 1B instead of the midsole 12A of the footwear 1A according to the first embodiment described above. The footwear 1B according to the present embodiment does not include the sockliner 20A of the footwear according to the first embodiment described above.

In the footwear 1B according to the present embodiment, the sole main body 12B is constructed from a shaped object produced by three-dimensional additive manufacturing. As the three-dimensional additive manufacturing, stereolithography-type three-dimensional additive manufacturing is adopted, for example.

More specifically, the sole main body 12B is formed from the three-dimensional mesh structure body 2A as illustrated in FIG. 7. Consequently, the whole of the sole main body 12B described above of the sole 11 as the footbed functions as the cushioning portion SA formed from the three-dimensional mesh structure body 2A. Note that the material of the sole main body 12B is not particularly limited. However, the same material as those for the sockliner 20A explained in the above-described first embodiment can be used.

In the footwear 1B according to the present embodiment, the cushioning portion SA formed from the three-dimensional mesh structure body 2A is also configured so that the conditions 1-1 to 1-7 described in the first configuration example described above, the conditions 2-1 to 2-7 described in the second configuration example described above, the conditions 3-1 to 3-7 described in the third configuration example described above, or the conditions 4-1 to 4-7 described in the fourth configuration example described above are satisfied.

Therefore, even in the case of the footwear 1B according to the present embodiment, it is possible to obtain an effect similar to the effect described in the first embodiment described above, and it is possible to provide footwear having a function more suitable for intended use.

### Third Embodiment

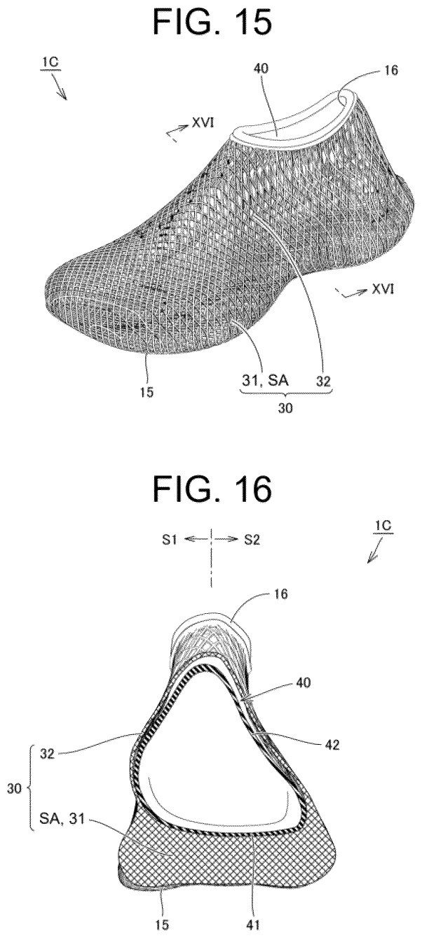

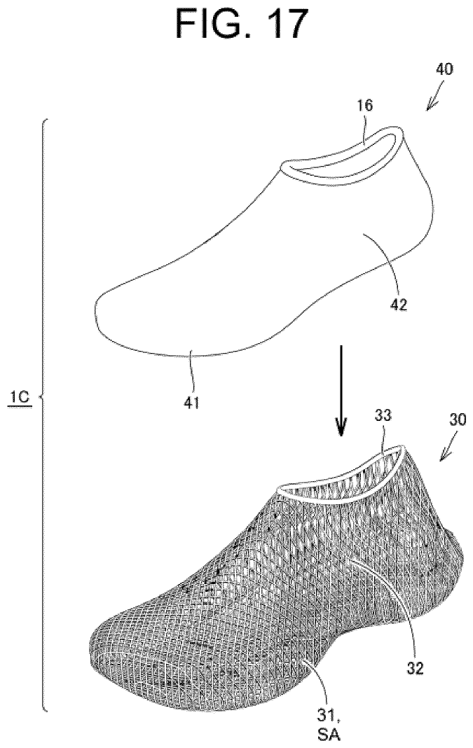

FIG. 15 is a perspective view of footwear according to a third embodiment, and FIG. 16 is a schematic cross-sectional view along the line XVI-XVI shown in FIG. 15. In addition, FIG. 17 is an exploded view of the footwear shown in FIG. 15. Hereinafter, footwear 1C according to the present embodiment will be described with reference to FIG. 15 to FIG. 17.

As illustrated in FIG. 15 to FIG. 17, the footwear 1C has a sock shape covering substantially the entire foot of the wearer (that is, a portion on the distal side of the ankle), and includes a shell 30 and an upper main body 40. Both the shell 30 and the upper main body 40 have a bag-like shape. The footwear 1C according to the present embodiment does not include the sockliner 20A of the footwear 1A according to the first embodiment described above.

The shell 30 includes a sole portion 31 and an outer upper portion 32. The sole portion 31 has a substantially flat shape, and the underside thereof forms the ground-contacting surface 15. The outer upper portion 32 stands from the peripheral edge of the sole portion 31. An opening portion 33 is provided in an upper part of the outer upper portion 32.

The upper main body 40 includes a bottom portion 41 and an inner upper portion 42. The bottom portion 41 has a substantially flat shape, and the topside thereof forms a support surface that supports the sole of the foot of the wearer foot when worn. The inner upper portion 42 stands from the peripheral edge of the bottom portion 41. An upper part of the inner upper portion 42 is provided with a shoe opening 16 through which the foot of the wearer is inserted.

The upper main body 40 is housed in the shell 30 such that the bottom portion 41 thereof is disposed above the sole portion 31 of the shell 30, and the inner upper portion 42 overlaps the outer upper portion 32 of the shell 30. Consequently, in the footwear 1C, the footbed is composed of the sole portion 31 of the shell 30 and the bottom portion 41 of the upper main body 40.

Since the upper main body 40 forms a portion to be in contact with the foot of the wearer, it is preferable that the upper main body 40 be formed from a member that can be flexibly deformed, and the upper main body 40 can be formed from, for example, woven fabric, knitted fabric, unwoven fabric, a synthetic leather, a resin, or the like. As described later, when woven fabric, knitted fabric, unwoven fabric, or the like of synthetic fibers having heat shrinkability is used, the foot of the wearer can be more easily fitted. Examples of the synthetic fibers having heat shrinkability include fibers mainly composed of, for example, polyester, polyurethane, or the like.

That is, in a case where the upper main body 40 is formed from woven fabric, knitted fabric, unwoven fabric, or the like of synthetic fibers having heat shrinkability, when the upper main body 40 is preliminarily formed into a bag shape, and heat treatment is performed in a state in which a last described later is inserted into the inside thereof, the shape is changed to a state in which the upper main body 40 is in close contact with the shaped surface of the last through heat shrinkage due to heating, and the shape after the change is held.

Accordingly, when a last adapting to the shape of the foot of the wearer is prepared, and the upper main body 40 is shaped using same as described above, the upper main body 40 fitted to the foot of the wearer can be produced. Further, when the heating treatment using the above-described last is performed in a state in which the upper main body 40 is incorporated into the shell 30, the upper main body 40 is also fitted to the shell 30, and it is possible to further improve fitting properties.

In the footwear 1C according to the present embodiment, the sole portion 31 is formed from a shaped object produced by three-dimensional additive manufacturing. As the three-dimensional additive manufacturing, stereolithography-type three-dimensional additive manufacturing is adopted, for example. The sole portion 31 of the shell 30 is formed from the three-dimensional mesh structure body 2A as illustrated in FIG. 7. Consequently, the whole of the sole portion 31 as the footbed functions as the cushioning portion SA formed from the three-dimensional mesh structure body 2A. Note that the material of the shell 30 is not particularly limited. However, the same material as those for the sockliner 20A explained in the above-described first embodiment can be used.

In the footwear 1C according to the present embodiment, the cushioning portion SA formed from the three-dimensional mesh structure body 2A is also configured so that the conditions 1-1 to 1-7 described in the first configuration example described above, the conditions 2-1 to 2-7 described in the second configuration example described above, the conditions 3-1 to 3-7 described in the third configuration example described above, or the conditions 4-1 to 4-7 described in the fourth configuration example described above are satisfied.

Therefore, even in the case of the footwear 1C according to the present embodiment, it is possible to obtain an effect similar to the effect described in the first embodiment described above, and it is possible to provide footwear having a function more suitable for intended use.

### SUMMARY OF DISCLOSURE IN EMBODIMENTS AND THE LIKE

Characteristic features disclosed in the above-described embodiments and the like are summarized as follows.

### Supplemental Note 1

Footwear including:
a footbed configured to support a sole of a foot of a wearer and including:
a ground-contacting surface;
a forefoot area configured to support a toe portion and a ball portion of the foot of the wearer;
a midfoot area configured to support an arch portion of the foot of the wearer; and
a rearfoot area configured to support a heel portion of the foot of the wearer,
in which the forefoot area, the midfoot area, and the rearfoot area are arranged in a continuous manner along a front-rear direction of the footwear,
the forefoot area includes a medial forefoot area and a lateral forefoot area defined by a shoe center of the footwear when viewed along a direction perpendicular to the ground-contacting surface,
the midfoot area includes a medial midfoot area and a lateral midfoot area defined by the shoe center of the footwear when viewed along the direction perpendicular to the ground-contacting surface,
the rearfoot area includes a medial rearfoot area and a lateral rearfoot area defined by the shoe center of the footwear when viewed along the direction perpendicular to the ground-contacting surface,
the footbed includes a cushioning portion configured of a three-dimensional mesh structure body in which multiple unit structures are repeatedly arranged to be adjacent to one another, the cushioning portion being across the medial forefoot area, the lateral forefoot area, the medial midfoot area, the lateral midfoot area, the medial rearfoot area, and the lateral rearfoot area,
an occupied volume ratio of the cushioning portion in a portion in the medial forefoot area is larger than an occupied volume ratio of the cushioning portion in a portion located in the lateral forefoot area,
an occupied volume ratio of the cushioning portion in a portion in the medial midfoot area is larger than an occupied volume ratio of the cushioning portion in a portion in the lateral midfoot area,
an occupied volume ratio of the cushioning portion in a portion in the medial rearfoot area is larger than an occupied volume ratio of the cushioning portion in a portion in the lateral rearfoot area,
the occupied volume ratio of the cushioning portion in the portion in the medial forefoot area is smaller than the occupied volume ratio of the cushioning portion in the portion in the medial midfoot area,
the occupied volume ratio of the cushioning portion in the portion in the lateral forefoot area is smaller than the occupied volume ratio of the cushioning portion in the portion in the lateral midfoot area,
the occupied volume ratio of the cushioning portion in the portion in the medial midfoot area is equal to or smaller than the occupied volume ratio of the cushioning portion in the portion in the medial rearfoot area, and
the occupied volume ratio of the cushioning portion in the portion in the lateral midfoot area is equal to or smaller than the occupied volume ratio of the cushioning portion in the portion in the lateral rearfoot area.

### Supplemental Note 2

Footwear including:
a footbed configured to support a sole of a foot of a wearer and including:
a ground-contacting surface;
a forefoot area configured to support a toe portion and a ball portion of the foot of the wearer;
a midfoot area configured to support an arch portion of the foot of the wearer; and
a rearfoot area configured to support a heel portion of the foot of the wearer, in which the forefoot area, the midfoot area, and the rearfoot area are arranged in a continuous manner along a front-rear direction of the footwear,
the forefoot area includes a medial forefoot area and a lateral forefoot area defined by a shoe center of the footwear when viewed along a direction perpendicular to the ground-contacting surface,
the midfoot area includes a medial midfoot area and a lateral midfoot area defined by the shoe center of the footwear when viewed along the direction perpendicular to the ground-contacting surface,
the rearfoot area includes a medial rearfoot area and a lateral rearfoot area defined by the shoe center of the footwear when viewed along the direction perpendicular to the ground-contacting surface,
the footbed includes a cushioning portion configured of a three-dimensional mesh structure body in which multiple unit structures are repeatedly arranged to be adjacent to one another, the cushioning portion being across the medial forefoot area, the lateral forefoot area, the medial midfoot area, the lateral midfoot area, the medial rearfoot area, and the lateral rearfoot area,
an occupied volume ratio of the cushioning portion in a portion located in the medial forefoot area is larger than an occupied volume ratio of the cushioning portion in a portion located in the lateral forefoot area,
an occupied volume ratio of the cushioning portion in a portion in the medial midfoot area is larger than an occupied volume ratio of the cushioning portion in a portion in the lateral midfoot area,
an occupied volume ratio of the cushioning portion in a portion in the medial rearfoot area is larger than an occupied volume ratio of the cushioning portion in a portion in the lateral rearfoot area,
the occupied volume ratio of the cushioning portion in the portion in the medial forefoot area is equal to or larger than the occupied volume ratio of the cushioning portion in the portion in the medial midfoot area,
the occupied volume ratio of the cushioning portion in the portion in the lateral forefoot area is equal to or larger than the occupied volume ratio of the cushioning portion in the portion in the lateral midfoot area,
the occupied volume ratio of the cushioning portion in the portion in the medial midfoot area is larger than the occupied volume ratio of the cushioning portion in the portion in the medial rearfoot area, and
the occupied volume ratio of the cushioning portion in the portion in the lateral midfoot area is larger than the occupied volume ratio of the cushioning portion in the portion in the lateral rearfoot area.

### Supplemental Note 3

Footwear including:
a footbed configured to support a sole of a foot of a wearer and including:
a ground-contacting surface;
a forefoot area configured to support a toe portion and a ball portion of the foot of the wearer;
a midfoot area configured to support an arch portion of the foot of the wearer; and
a rearfoot area configured to support a heel portion of the foot of the wearer,
in which the forefoot area, the midfoot area, and the rearfoot area are arranged in a continuous manner along a front-rear direction of the footwear,
the forefoot area includes a medial forefoot area and a lateral forefoot area defined by a shoe center of the footwear when viewed along a direction perpendicular to the ground-contacting surface,
the midfoot area includes a medial midfoot area and a lateral midfoot area defined by the shoe center of the footwear when viewed along the direction perpendicular to the ground-contacting surface,
the rearfoot area includes a medial rearfoot area and a lateral rearfoot area defined by the shoe center of the footwear when viewed along the direction perpendicular to the ground-contacting surface,
the footbed includes a cushioning portion configured of a three-dimensional mesh structure body in which multiple unit structures are repeatedly arranged to be adjacent to one another, the cushioning portion being across the medial forefoot area, the lateral forefoot area, the medial midfoot area, the lateral midfoot area, the medial rearfoot area, and the lateral rearfoot area,
an occupied volume ratio of the cushioning portion in a portion in the medial forefoot area is smaller than an occupied volume ratio of the cushioning portion in a portion in the lateral forefoot area,
an occupied volume ratio of the cushioning portion in a portion in the medial midfoot area is smaller than an occupied volume ratio of the cushioning portion in a portion in the lateral midfoot area,
an occupied volume ratio of the cushioning portion in a portion in the medial rearfoot area is smaller than an occupied volume ratio of the cushioning portion in a portion in the lateral rearfoot area,
the occupied volume ratio of the cushioning portion in the portion in the medial forefoot area is smaller than the occupied volume ratio of the cushioning portion in the portion in the medial midfoot area,
the occupied volume ratio of the cushioning portion in the portion in the lateral forefoot area is smaller than the occupied volume ratio of the cushioning portion in the portion in the lateral midfoot area,
the occupied volume ratio of the cushioning portion in the portion in the medial midfoot area is equal to or smaller than the occupied volume ratio of the cushioning portion in the portion in the medial rearfoot area, and
the occupied volume ratio of the cushioning portion in the portion in the lateral midfoot area is equal to or smaller than the occupied volume ratio of the cushioning portion in the portion in the lateral rearfoot area.

### Supplemental Note 4

Footwear including:
a footbed configured to support a sole of a foot of a wearer and including:
a ground-contacting surface;
a forefoot area configured to support a toe portion and a ball portion of the foot of the wearer;
a midfoot area configured to support an arch portion of the foot of the wearer; and
a rearfoot area configured to support a heel portion of the foot of the wearer,
in which the forefoot area, the midfoot area, and the rearfoot area are arranged in a continuous manner along a front-rear direction of the footwear,
the forefoot area includes a medial forefoot area and a lateral forefoot area defined by a shoe center of the footwear when viewed along a direction perpendicular to the ground-contacting surface,
the midfoot area includes a medial midfoot area and a lateral midfoot area defined by the shoe center of the footwear when viewed along the direction perpendicular to the ground-contacting surface,
the rearfoot area includes a medial rearfoot area and a lateral rearfoot area defined by the shoe center of the footwear when viewed along the direction perpendicular to the ground-contacting surface,
the footbed includes a cushioning portion configured of a three-dimensional mesh structure body in which multiple unit structures are repeatedly arranged to be adjacent to one another, the cushioning portion being located across the medial forefoot area, the lateral forefoot area, the medial midfoot area,
the lateral midfoot area, the medial rearfoot area, and the lateral rearfoot area,
an occupied volume ratio of the cushioning portion in a portion in the medial forefoot area is smaller than an occupied volume ratio of the cushioning portion in a portion in the lateral forefoot area,
an occupied volume ratio of the cushioning portion in a portion in the medial midfoot area is smaller than an occupied volume ratio of the cushioning portion in a portion in the lateral midfoot area,
an occupied volume ratio of the cushioning portion in a portion in the medial rearfoot area is smaller than an occupied volume ratio of the cushioning portion in a portion in the lateral rearfoot area,
the occupied volume ratio of the cushioning portion in the portion in the medial forefoot area is equal to or larger than the occupied volume ratio of the cushioning portion in the portion in the medial midfoot area,
the occupied volume ratio of the cushioning portion in the portion in the lateral forefoot area is equal to or larger than the occupied volume ratio of the cushioning portion in the portion in the lateral midfoot area,
the occupied volume ratio of the cushioning portion in the portion in the medial midfoot area is larger than the occupied volume ratio of the cushioning portion in the portion in the medial rearfoot area, and
the occupied volume ratio of the cushioning portion in the portion in the lateral midfoot area is larger than the occupied volume ratio of the cushioning portion in the portion in the lateral rearfoot area.

### Supplemental Note 5

The footwear according to any of supplemental notes 1 to 4, in which the three-dimensional mesh structure body has a three-dimensional lattice structure.

### Supplemental Note 6

The footwear according to any of supplemental notes 1 to 4, in which the three-dimensional mesh structure body has a three-dimensional wall structure configured by a wall, and the outer shape of the wall is defined by a pair of flat or curved surfaces parallel to each other.

### Supplemental Note 7

The footwear according to supplemental note 6, in which the three-dimensional wall structure includes a structure based on a triply periodic minimal surface as a reference surface, with a thickness added to the reference surface.

### Supplemental Note 8

The footwear according to supplemental note 6, in which the three-dimensional wall structure includes a structure based on, as a reference surface, multiple planes arranged to intersect with each other and to have a cavity therein, with a thickness added to the reference surface.

### Supplemental Note 9

The footwear according to any of supplemental notes 1 to 8, in which the cushioning portion is configured of a single object shaped by three-dimensional additive manufacturing.

### Supplemental Note 10

The footwear according to any of supplemental notes 1 to 9, in which the footbed includes a sole, and
the sole includes the cushioning portion.

### Supplemental Note 11

The footwear according to any of supplemental notes 1 to 9, in which the footbed includes a sole and a sockliner, and
the sockliner includes the cushioning portion.

### OTHER MODES AND THE LIKE

In the above-described embodiments and the like, as uses of the footwear, running shoes intended for heel strike running, midfoot strike running, forefoot strike running, or the like, and shoes used for a specific sports typified by tennis, table tennis, basketball, or the like have been particularly exemplified and described. However, the use (sports or the like) of the shoes is not limited thereto.

The above-described embodiments and the like disclosed herein are illustrative and non-restrictive in all respects.

The technical scope of the present invention is defined by the claims and includes all modifications within the meaning and scope equivalent to the description of the claims.

What is claimed is:

1. Footwear comprising:
a footbed configured to support a sole of a foot of a wearer and including:
a ground-contacting surface;
a forefoot area configured to support a toe portion and a ball portion of the foot of the wearer;
a midfoot area configured to support an arch portion of the foot of the wearer; and
a rearfoot area configured to support a heel portion of the foot of the wearer,
wherein
the forefoot area, the midfoot area, and the rearfoot area are arranged in a continuous manner along a front-rear direction of the footwear,
the forefoot area includes a medial forefoot area and a lateral forefoot area defined by a shoe center of the footwear when viewed along a direction perpendicular to the ground-contacting surface,
the midfoot area includes a medial midfoot area and a lateral midfoot area defined by the shoe center of the footwear when viewed along the direction perpendicular to the ground-contacting surface,
the rearfoot area includes a medial rearfoot area and a lateral rearfoot area defined by the shoe center of the footwear when viewed along the direction perpendicular to the ground-contacting surface,
the footbed includes a cushioning portion configured of a three-dimensional mesh structure body in which multiple unit structures are repeatedly arranged to be adjacent to one another, the cushioning portion being across the medial forefoot area, the lateral forefoot area, the medial midfoot area, the lateral midfoot area, the medial rearfoot area, and the lateral rearfoot area,
an occupied volume ratio of the cushioning portion in a portion in the medial forefoot area is larger than an occupied volume ratio of the cushioning portion in a portion located in the lateral forefoot area,
an occupied volume ratio of the cushioning portion in a portion in the medial midfoot area is larger than an occupied volume ratio of the cushioning portion in a portion in the lateral midfoot area,
an occupied volume ratio of the cushioning portion in a portion in the medial rearfoot area is larger than an occupied volume ratio of the cushioning portion in a portion in the lateral rearfoot area,
the occupied volume ratio of the cushioning portion in the portion in the medial forefoot area is smaller than the occupied volume ratio of the cushioning portion in the portion in the medial midfoot area,
the occupied volume ratio of the cushioning portion in the portion in the lateral forefoot area is smaller than the occupied volume ratio of the cushioning portion in the portion in the lateral midfoot area,
the occupied volume ratio of the cushioning portion in the portion in the medial midfoot area is equal to or smaller than the occupied volume ratio of the cushioning portion in the portion in the medial rearfoot area, and
the occupied volume ratio of the cushioning portion in the portion in the lateral midfoot area is equal to or smaller than the occupied volume ratio of the cushioning portion in the portion in the lateral rearfoot area.

2. Footwear comprising:
a footbed configured to support a sole of a foot of a wearer and including:
a ground-contacting surface;
a forefoot area configured to support a toe portion and a ball portion of the foot of the wearer;
a midfoot area configured to support an arch portion of the foot of the wearer; and
a rearfoot area configured to support a heel portion of the foot of the wearer,
wherein
the forefoot area, the midfoot area, and the rearfoot area are arranged in a continuous manner along a front-rear direction of the footwear,
the forefoot area includes a medial forefoot area and a lateral forefoot area defined by a shoe center of the footwear when viewed along a direction perpendicular to the ground-contacting surface,
the midfoot area includes a medial midfoot area and a lateral midfoot area defined by the shoe center of the footwear when viewed along the direction perpendicular to the ground-contacting surface,
the rearfoot area includes a medial rearfoot area and a lateral rearfoot area defined by the shoe center of the footwear when viewed along the direction perpendicular to the ground-contacting surface,
the footbed includes a cushioning portion configured of a three-dimensional mesh structure body in which multiple unit structures are repeatedly arranged to be adjacent to one another, the cushioning portion being across the medial forefoot area, the lateral forefoot area, the medial midfoot area, the lateral midfoot area, the medial rearfoot area, and the lateral rearfoot area,
an occupied volume ratio of the cushioning portion in a portion located in the medial forefoot area is larger than an occupied volume ratio of the cushioning portion in a portion located in the lateral forefoot area,
an occupied volume ratio of the cushioning portion in a portion in the medial midfoot area is larger than an occupied volume ratio of the cushioning portion in a portion in the lateral midfoot area,
an occupied volume ratio of the cushioning portion in a portion in the medial rearfoot area is larger than an occupied volume ratio of the cushioning portion in a portion in the lateral rearfoot area,
the occupied volume ratio of the cushioning portion in the portion in the medial forefoot area is equal to or larger than the occupied volume ratio of the cushioning portion in the portion in the medial midfoot area,
the occupied volume ratio of the cushioning portion in the portion in the lateral forefoot area is equal to or larger than the occupied volume ratio of the cushioning portion in the portion in the lateral midfoot area,
the occupied volume ratio of the cushioning portion in the portion in the medial midfoot area is larger than the occupied volume ratio of the cushioning portion in the portion in the medial rearfoot area, and
the occupied volume ratio of the cushioning portion in the portion in the lateral midfoot area is larger than the occupied volume ratio of the cushioning portion in the portion in the lateral rearfoot area.

3. Footwear comprising:
a footbed configured to support a sole of a foot of a wearer and including:
a ground-contacting surface;
a forefoot area configured to support a toe portion and a ball portion of the foot of the wearer;
a midfoot area configured to support an arch portion of the foot of the wearer; and
a rearfoot area configured to support a heel portion of the foot of the wearer,
wherein
the forefoot area, the midfoot area, and the rearfoot area are arranged in a continuous manner along a front-rear direction of the footwear,
the forefoot area includes a medial forefoot area and a lateral forefoot area defined by a shoe center of the footwear when viewed along a direction perpendicular to the ground-contacting surface,
the midfoot area includes a medial midfoot area and a lateral midfoot area defined by the shoe center of the footwear when viewed along the direction perpendicular to the ground-contacting surface,
the rearfoot area includes a medial rearfoot area and a lateral rearfoot area defined by the shoe center of the footwear when viewed along the direction perpendicular to the ground-contacting surface,
the footbed includes a cushioning portion configured of a three-dimensional mesh structure body in which multiple unit structures are repeatedly arranged to be adjacent to one another, the cushioning portion being located across the medial forefoot area, the lateral forefoot area, the medial midfoot area, the lateral midfoot area, the medial rearfoot area, and the lateral rearfoot area,
an occupied volume ratio of the cushioning portion in a portion in the medial forefoot area is smaller than an occupied volume ratio of the cushioning portion in a portion in the lateral forefoot area,
an occupied volume ratio of the cushioning portion in a portion in the medial midfoot area is smaller than an occupied volume ratio of the cushioning portion in a portion in the lateral midfoot area,
an occupied volume ratio of the cushioning portion in a portion in the medial rearfoot area is smaller than an occupied volume ratio of the cushioning portion in a portion in the lateral rearfoot area,
the occupied volume ratio of the cushioning portion in the portion in the medial forefoot area is equal to or larger than the occupied volume ratio of the cushioning portion in the portion in the medial midfoot area,
the occupied volume ratio of the cushioning portion in the portion in the lateral forefoot area is equal to or larger than the occupied volume ratio of the cushioning portion in the portion in the lateral midfoot area,
the occupied volume ratio of the cushioning portion in the portion in the medial midfoot area is larger than the occupied volume ratio of the cushioning portion in the portion in the medial rearfoot area, and
the occupied volume ratio of the cushioning portion in the portion in the lateral midfoot area is larger than the occupied volume ratio of the cushioning portion in the portion in the lateral rearfoot area.

4. The footwear according to claim 1, wherein
the three-dimensional mesh structure body has a three-dimensional lattice structure.

5. The footwear according to claim 1, wherein
the three-dimensional mesh structure body has a three-dimensional wall structure configured by a wall, and an outer shape of the wall is defined by a pair of flat or curved surfaces parallel to each other.

6. The footwear according to claim 5, wherein
the three-dimensional wall structure includes a structure based on a triply periodic minimal surface as a reference surface, with a thickness added to the reference surface.

7. The footwear according to claim 5, wherein
the three-dimensional wall structure includes a structure based on, as a reference surface, multiple planes arranged to intersect with each other and to have a cavity therein, with a thickness added to the reference surface.

8. The footwear according to claim 1, wherein
the cushioning portion is configured of a single object shaped by three-dimensional additive manufacturing.

9. The footwear according to claim 1, wherein
the footbed includes a sole, and
the sole includes the cushioning portion.

10. The footwear according to claim 1, wherein
the footbed includes a sole and a sockliner, and
the sockliner includes the cushioning portion.

11. The footwear according to claim 2, wherein
the three-dimensional mesh structure body has a three-dimensional lattice structure.

12. The footwear according to claim 3, wherein
the three-dimensional mesh structure body has a three-dimensional lattice structure.

13. The footwear according to claim 2, wherein
the three-dimensional mesh structure body has a three-dimensional wall structure configured by a wall, and an outer shape of the wall is defined by a pair of flat or curved surfaces parallel to each other.

14. The footwear according to claim 3, wherein
the three-dimensional mesh structure body has a three-dimensional wall structure configured by a wall, and an outer shape of the wall is defined by a pair of flat or curved surfaces parallel to each other.

15. The footwear according to claim 2, wherein
the cushioning portion is configured of a single object shaped by three-dimensional additive manufacturing.

16. The footwear according to claim 3, wherein
the cushioning portion is configured of a single object shaped by three-dimensional additive manufacturing.

17. The footwear according to claim 2, wherein
the footbed includes a sole, and
the sole includes the cushioning portion.

18. The footwear according to claim 3, wherein
the footbed includes a sole, and
the sole includes the cushioning portion.

19. The footwear according to claim 2, wherein
the footbed includes a sole and a sockliner, and
the sockliner includes the cushioning portion.

20. The footwear according to claim 3, wherein
the footbed includes a sole and a sockliner, and
the sockliner includes the cushioning portion.
